(19) United States
(12) Patent Application Publication
(10) Pub. No.: US 2024/0307847 A1
(43) Pub. Date: Sep. 19, 2024

(54) HALLOYSITE-KAOLIN DERIVATISED NANOPOROUS CARBON MATERIALS AND PREPARATION AND USES THEREOF

(71) Applicant: Andromeda IP Pty Ltd, South Australia (AU)

(72) Inventors: Ajayan Vinu, Callaghan (AU); Kavitha Ramadass, Callaghan (AU)

(21) Appl. No.: 18/576,072

(22) PCT Filed: Jul. 1, 2022
(86) PCT No.: PCT/AU2022/050691

§ 371 Date: Jan. 2, 2024

(30) Foreign Application Priority Data
Jul. 2, 2021 (AU) 2021902019

(51) Int. Cl. B01J 20/20; B01D 53/02; B01J 20/28; B01J 20/30; C01B 32/318; C01B 32/378; H01G 11/24; H01G 11/34; H01G 11/36; H01M 4/02; H01M 4/587

(52) U.S. Cl. CPC B01J 20/205; B01D 53/02; B01J 20/28066; B01J 20/28076; B01J 20/3078; C01B 32/318; C01B 32/378; H01M 4/587; B01D 2253/102; B01D 2253/25; B01D 2253/306; B01D 2253/311; B01D 2257/504; C01P 2006/40; H01G 11/24; H01G 11/34; H01G 11/36; H01M 2004/027

(57) ABSTRACT

The present disclosure relates to a heteroatom doped activated nanoporous carbon material prepared from a template material comprising natural halloysite-kaolin nanoclays, a carbon precursor, a heteroatom dopant precursor and an activating agent, wherein the doped activated nanoporous carbon material exhibits a flake and nanotubular morphology and bears surface heteroatom functionalities.

### PRIORITY DOCUMENT

The present application claims priority from Australian Provisional Patent Application No. 2021902019 titled “HALLOYSITE-KAOLIN DERIVATISED NANOPOROUS CARBON MATERIALS AND PREPARATION AND USES THEREOF” and filed on 2 Jul. 2021, the content of which is hereby incorporated by reference in its entirety.

### TECHNICAL FIELD

The present disclosure generally relates to derivatised activated nanoporous carbon materials, methods for their preparation and uses thereof. More particularly, the present disclosure relates to N-doped activated nanoporous carbon materials prepared from natural halloysite-kaolin nanoclays, methods for their preparation and uses thereof.

### BACKGROUND

Due to the natural abundance of sodium, sodium-ion batteries have received much interest and are promising to be complementary to lithium-ion batteries. Sodium-ion batteries typically consist of hard carbon anodes and layered transition metal oxide cathodes. One of the challenges is the design of high-performance and low-cost anode materials.

Supercapacitors can be recharged very quickly and release a large amount of power. Supercapacitors are ideal for energy storage that undergoes frequent charge and discharge cycles at high current and short duration. They have gained extensive attention as they may emerge as a solution for many application-specific power systems, especially for their promising use in electric vehicles. In this context, huge efforts are being made in the development of new materials that may find use in supercapacitors.

Supercapacitors can be classified into three types: electric double layer capacitors (EDLC), pseudocapacitors, and hybrid types formed by a combination of EDLC and pseudocapacitor. EDLCs do not have a conventional dielectric but use virtual plates made of two layers of the same substrate, which results in the effective separation of charge despite the vanishingly thin (on the order of nanometers) physical separation of the layers. The electrode-electrolyte interface incorporates a double layer formed between the electrolyte ions and electronic charges on the electrode. EDLCs store energy by means of a static charge as opposed to an electrochemical reaction. The high porosity of the electrode materials for EDLCs allows for the plates to have much larger surface area within a given volume, which in turn leads to high specific capacitances.

It is postulated that increasing atmospheric concentration of CO₂ is one of the main reasons behind climate change and other deleterious impacts on our environment. Attempts are being made toward the capture and utilisation of large amounts of CO₂ in order to mitigate its influence on climate change. For instance, montmorillonite clay, smectite, sepiolite, hydrotalcite, saponite, and hectorite have been applied as CO₂ adsorbents.

Porous carbon has been suggested as a candidate material for anode materials, supercapacitors, and adsorbents owing to its cost-effectiveness, high surface area, tunable pore structure, thermal and chemical stability and promising electrochemical performances, etc. In this regard, different techniques have been adopted to enhance the surface properties of porous carbons. A high surface area can be achieved by chemical activation of carbon with KOH, CO₂, NH₃, and H₂O with surface area values above 1000 m²/g. (see Peng, Z.; Guo, Z.; Chu, W.; Wei, M. Facile Synthesis of High-Surface-Area Activated Carbon from Coal for Supercapacitors and High CO₂ Sorption. RSC Adv. 2016, 6, 42019-42028.) A solid-state activation technique has been developed using solid ZnCl₂ or KOH as the activating agent to prepare a number of activated porous carbon materials with a high specific surface area and large pore volumes that is responsible for very high CO₂ sorption capacity. (see, for example, Singh, G.; Lakhi, K. S.; Ramadass, K.; Sathish, C. I.; Vinu, A. High-Performance Biomass-Derived Activated Porous Biocarbons for Combined Pre- and Post-Combustion CO₂ Capture. ACS Sustainable Chem. Eng. 2019, 7, 7412-7420; Singh, G.; Lakhi, K. S.; Sil, S.; Bhosale, S. V.; Kim, I.; Albahily, K.; Vinu, A. Biomass derived Porous Carbon for CO₂ Capture. Carbon 2019, 148, 164-186; Singh, G.; Kim, I. Y.; Lakhi, K. S.; Joseph, S.; Srivastava, P.; Naidu, R.; Vinu, A. Heteroatom Functionalized Activated Porous Biocarbons and their Excellent Performance for CO₂ Capture at High pressure. J. Mater. Chem. A 2017, 5, 21196-21204; Singh, G.; Kim, I. Y.; Lakhi, K. S.; Srivastava, P.; Naidu, R.; Vinu, A. Single Step Synthesis of Activated Bio-Carbons with a High Surface Area and their Excellent CO₂ Adsorption Capacity. Carbon 2017, 116, 448-455.) It has also been reported that the morphology of nanostructures influences the final surface properties of porous carbon materials. In this context, chemical and physical methods such as soft and hard templating have been used to synthesize several types of porous carbon materials with different structures and morphologies. The most commonly used template to prepare ordered mesoporous carbons with high specific surface area is ordered mesoporous silica (see Peng, L.; Hung, C.-T.; Wang, S.; Zhang, X.; Zhu, X.; Zhao, Z.; Wang, C.; Tang, Y.; Li, W.; Zhao, D. Versatile Nanoemulsion Assembly Approach to Synthesize Functional Mesoporous Carbon Nanospheres with Tunable Pore Sizes and Architectures. J. Am. Chem. Soc. 2019, 141, 7073-7080.). However, expensive chemicals and complex synthesis procedures are required for the synthesis of ordered mesoporous silica, which limits its large-scale commercialisation.

Natural halloysite nanotubes (HNTs), a low-cost and naturally available clay material, has been used to prepare an activated non-doped nanoporous carbon (AHNC) with a flake and nanotubular morphology and a high specific surface area (see Kavitha Ramadass; C. I. Sathish; Sujanya MariaRuban; Gopalakrishnan Kothandam; Stalin Joseph; Gurwinder Singh; Sungho Kim; Wangsoo Cha; Ajay Karakoti; Tony Belperio; Jia Bao Yi; and Ajayan Vinu. Carbon Nanoflakes and Nanotubes from Halloysite Nanoclays and their Superior Performance in CO₂ Capture and Energy Storage. ACS Applied Materials & Interfaces 2020 12 (10), 11922-11933). However, a double-step activation which involves heating first at 600° C. for 5 h followed by washing with HCl and further heating at 900° C. for 5 h was required for preparation of the AHNC. This procedure was necessary to limit the transformation of kaolinite-halloysite into metakaolin at temperature above 600° C. Metakaolin is an ultra-stable and complex amorphous material, and difficult to dissolve using HF. The heating at 900° C. was required to increase the degree of graphitization of carbon walls.

There remains a need for improved nanoporous carbon materials and/or improved methods for the fabrication of nanoporous carbon materials having at least one of high specific surface area, large pore volume, surface functionalities, and a mixture of micropores and mesopores, so that they may find use in applications including, but not limited to anode materials for sodium-ion or lithium-ion batteries, in supercapacitors and/or in CO₂ adsorption.

### SUMMARY

In a first aspect, the present disclosure provides a doped activated nanoporous carbon material prepared from a template material comprising natural halloysite-kaolin nanoclays, a carbon precursor, a heteroatom dopant precursor and an activating agent, wherein the doped activated nanoporous carbon material exhibits a flake and nanotubular morphology and bears surface heteroatom functionalities.

In some embodiments, the template material consists of natural halloysite-kaolin nanoclays. In some further embodiments, the natural halloysite-kaolin nanoclays contain up to about 60% by weight of kaolinite and about 40% by weight of halloysite. In some further embodiments, the natural halloysite-kaolin nanoclays contain more than about 80% by weight of halloysite nanotubes.

In some embodiments, the carbon precursor is a carbohydrate-based compound. In some further embodiments, the carbohydrate-based compound is a sugar-based compound. In certain of these embodiments, the sugar-based compound is selected from the group consisting of sucrose, glucose, polysaccharides, and fructose. In some exemplary embodiments, the polysaccharides are selected from the group consisting of cellulose, chitosan and starch.

In some embodiments, the heteroatom dopant precursor is a nitrogen precursor. The nitrogen precursor may be a compound containing one or more nitrogen atoms. For example, the nitrogen precursor may be selected from the group consisting of aminoguanidine, aminoguanidine hydrochloride, aminotriazoles, urea, chitosan, cyanamide, dicyanamide, thiourea, melamine, casein, polyaniline, polypyrrole, aminotetrazoles, and aminotriazines. In some further embodiments, the nitrogen precursor is an aminotriazole. In certain exemplary embodiments, the nitrogen precursor is 3-amino-1,2,4-triazole. The nitrogen precursor may be a compound containing one or more nitrogen atoms and one or more other heteroatoms, such as sulfur.

In some embodiments, the heteroatom dopant precursor is a sulfur precursor. The sulfur precursor may be a carbon compound containing one or more sulfur atoms. For example, the sulfur precursor may be selected from the group consisting of diphenyl disulphide, polyphenylene sulfide, bis(trimethylsilyl) sulfide, alkyl thiol, and thiophene. Alternatively, the sulfur precursor may be an inorganic compound containing one or more sulfur atoms. For example, the sulfur precursor may be selected from the group consisting of sulphur powder, sodium sulphide, sodium dithionite, and sodium thiosulfate. Alternatively, the sulfur precursor may be a carbon containing compound containing one or more sulfur atoms and one or more other heteroatoms, such as nitrogen. For example, the sulfur precursor may be selected from the group consisting of thiourea, thioacetamide, L-cysteine, methionine, dithiocarbamates, dithiooxamide, thiazoles such as 2-aminothiazole, 5-amino-1,3,4-thiadiazole-2-thiol, thiosemicarbazide, and thiocarbohydrazide.

In some embodiments, the heteroatom dopant precursor is a boron precursor. The boron precursor may be a compound containing one or more boron atoms. Suitable boron precursors include boric acid, ammonia borane (borazane), diborane, trimethyl boron, colemanite, boron trioxide, trimethoxy borane, sodium borate, borax, sodium borohydride, dimeric diborazane, trimeric triborazane, boron trifluoride, boron trichloride, and phenyl borate.

In some embodiments, the heteroatom dopant precursor is an oxygen precursor. The oxygen precursor may be a compound containing one or more oxygen atoms. Suitable oxygen precursors include boric acid, boron trioxide, sodium borate, and borax.

The heteroatom dopant precursor may be any combination of two or more of the aforementioned precursors, such as a nitrogen precursor and a boron precursor, a nitrogen precursor and a sulfur precursor, a boron precursor, a sulfur precursor, a boron precursor and an oxygen precursor, a nitrogen precursor and an oxygen precursor, a sulfur precursor and an oxygen precursor or a nitrogen precursor, boron precursor and a sulfur precursor. These combinations will give rise to, for example, boron carbon nitride materials.

In some embodiments, the activating agent is selected from the group consisting of a zinc compound, phosphoric acid, potassium acetate, sodium hydroxide, potassium carbonate, sodium carbonate, sodium chloride, potassium chloride, calcium chloride, carbon dioxide (CO₂), ammonium carbonate, and ammonium persulfate. In some exemplary embodiments, the zinc compound is selected from the group consisting of zinc chloride (ZnCl₂) and zinc oxide (ZnO).

In some embodiments, the carbon precursor and the template material are in a weight ratio of from about 2:10 to about 4:10. In some exemplary embodiments, the carbon precursor and the template material are in a weight ratio of about 3:10.

In some embodiments, the heteroatom dopant precursor and the template material are in a weight ratio of about 1:12 to about 1:4. In some exemplary embodiments, the heteroatom dopant precursor and the template material are in a weight ratio of about 1:10.

In some embodiments, the activating agent and the template material are in a weight ratio of from about 1:6 to about 4:3. In some exemplary embodiments, the activating agent and the template material are in a weight ratio of about 2:3.

In some embodiments, the doped activated nanoporous carbon material has a heteroatom content of from about 0.25% to about 15.00% by weight. The heteroatom content of the doped activated nanoporous carbon material will depend, at least in part, on factors such as the synthesis method, the carbonisation temperature and precursor selection.

In some embodiments, the doped activated nanoporous carbon material has nitrogen (N) content of from about 0.25% to about 15.00% by weight.

In some embodiments, the doped activated nanoporous carbon material has a sulfur (S) content of from about 0.30% to about 2.28% by weight and nitrogen (N) content of from about (9.25%) to 19.76%.

In some embodiments, the doped activated nanoporous carbon material has a boron (B) content and oxygen (O) content of from about 11.10% to 26.92% by weight.

In some embodiments, the doped activated nanoporous carbon material has a specific capacitance of more than about 200 F/g at a current density of 0.3 A/g. In some embodiments, the doped activated nanoporous carbon material has a specific capacitance of about 299 F/g at a current density of 0.3 A/g. In some exemplary embodiments, the doped activated nanoporous carbon material has a specific capacitance of about 299 F/g, about 228 F/g or about 194 F/g at a current density of 0.3 A/g, 0.5 A/g, and 1 A/g.

In some embodiments, the doped activated nanoporous carbon material has a specific surface area of from about 1350 m²/g to about 1700 m²/g. In some further embodiments, the-doped activated nanoporous carbon material has a specific surface area of from about 1500 m²/g to about 1700 m²/g. In some further embodiments, the doped activated nanoporous carbon material has a specific surface area of from about 1600 m²/g to about 1700 m²/g.

In some embodiments, the doped activated nanoporous carbon material has a pore volume of from about 1.0 cm³/g to about 1.6 cm³/g. In some further embodiments, the doped activated nanoporous carbon material has a pore volume of from about 1.3 cm³/g to about 1.6 cm³/g. In some further embodiments, the doped activated nanoporous carbon material has a pore volume of from about 1.4 cm³/g to about 1.6 cm³/g.

In some embodiments, the doped activated nanoporous carbon material has a specific area of about 1700 m²/g and a pore volume of about 1.465 cm³/g.

In some embodiments, the doped activated nanoporous carbon material has a CO₂ adsorption capacity of at least about 22.5 mmol/g when determined at 0° C. and 30 bar. In some further embodiments, the doped activated nanoporous carbon material has a CO₂ adsorption capacity of about 24.4 mmol/g when determined at 0° C. and 30 bar.

In a second aspect, the present disclosure provides a method of preparing a doped activated nanoporous carbon material, the method including:
(a) loading a template material comprising natural halloysite-kaolin nanoclays with a carbon precursor and a heteroatom dopant precursor;
(b) removing moisture and volatiles from the loaded template material obtained from step (a) by heating;
(c) producing a composition comprising the loaded template material obtained from step (b) and an activating agent;
(d) activating and carbonising the composition obtained from step (c) at a temperature of about 600° C. to about 900° C.; and
(e) removing the template material and the activating agent from the composition obtained from step (d).

In some embodiments, for step (a), the template material consists of natural halloysite-kaolin nanoclays. In some further embodiments, the natural halloysite-kaolin nanoclays contain up to about 60% by weight of kaolinite and about 40% by weight of halloysite. In some further embodiments, the natural halloysite-kaolin nanoclays contain more than about 80% by weight of halloysite nanotubes.

In some embodiments, for step (a), the carbon precursor is a carbohydrate-based compound. In some further embodiments, for step (a), the carbohydrate-based compound is a sugar-based compound. In certain of these embodiments, the sugar-based compound is selected from the group consisting of sucrose, glucose, fructose and polysaccharides. In some exemplary embodiments, the polysaccharides are selected from the group consisting of cellulose, chitosan and starch.

In some embodiments, for step (a) the heteroatom dopant precursor is a nitrogen precursor. The nitrogen precursor may be a carbon compound containing one or more nitrogen atoms. For example, the nitrogen precursor may be selected from the group consisting of aminoguanidine, aminoguanidine hydrochloride, aminotriazoles, urea, chitosan, cyanamide, dicyanamide, thiourea, melamine, casein, polyaniline, polypyrrole, aminotetrazoles, and aminotriazines. In some further embodiments, the nitrogen precursor is an aminotriazole. In certain exemplary embodiments, the nitrogen precursor is 3-amino-1,2,4-triazole.

In some embodiments, for step (a) the heteroatom dopant precursor is a sulfur precursor. The sulfur precursor may be a carbon compound containing one or more sulfur atoms. For example, the sulfur precursor may be selected from the group consisting of diphenyl disulphide, polyphenylene sulfide, bis(trimethylsilyl) sulfide, alkyl thiol, and thiophene. Alternatively, the sulfur precursor may be an inorganic compound containing one or more sulfur atoms. For example, the sulfur precursor may be selected from the group consisting of sulphur powder, sodium sulphide, sodium dithionite, and sodium thiosulfate. Alternatively, the sulfur precursor may be a carbon containing compound containing one or more sulfur atoms and one or more other heteroatoms, such as nitrogen. For example, the sulfur precursor may be selected from the group consisting of thiourea, thioacetamide, L-cysteine, methionine, dithiocarbamates, dithiooxamide, thiazoles such as 2-aminothiazole, 5-amino-1,3,4-thiadiazole-2-thiol, thiosemicarbazide, and thiocarbohydrazide.

In some embodiments, for step (a) the heteroatom dopant precursor is a boron precursor. The boron precursor may be a compound containing one or more boron atoms. Suitable boron precursors include boric acid, ammonia borane (borazane), diborane, trimethyl boron, colemanite, boron trioxide, trimethoxy borane, sodium borate, borax, sodium borohydride, dimeric diborazane, trimeric triborazane, boron trifluoride, boron trichloride, and phenyl borate.

In some embodiments, for step (a) the heteroatom dopant precursor is an oxygen precursor. The oxygen precursor may be a compound containing one or more oxygen atoms. Suitable oxygen precursors include boric acid, boron trioxide, sodium borate, and borax.

In some embodiments, for step (a), the carbon precursor and the template material are in a weight ratio of from about 2:10 to about 4:10. In some exemplary embodiments, the carbon precursor and the template material are in a ratio by weight of about 3:10.

In some embodiments, for step (a), the heteroatom dopant precursor and the template material are in a weight ratio of about 1:12 to about 1:4. In some exemplary embodiments, the heteroatom dopant precursor and the template material are in a weight ratio of about 1:10.

In some embodiments, for step (a), the heteroatom dopant precursor and the carbon precursor are loaded onto the template material through impregnation. In some further embodiments, a solution of the carbon precursor in water and a solution of the heteroatom dopant precursor in water are prepared separately and then added dropwise to the template material to form loaded template material. In certain of these embodiments, the water used to prepare the solutions and the template material is in a weight ratio of from about 1:1 to about 2:1. In some exemplary embodiments, the water used to prepare the solutions and the template material is in a weight ratio of about 4:3.

In some embodiments, the template material is further loaded with a dehydration agent before step (b). In some further embodiments, the dehydration agent is selected from the group consisting of sulfuric acid, formic acid, acetic acid and citric acid.

In some embodiments, for step (b), the removal of moisture and volatiles is conducted through heating. In some further embodiments, for step (b), the loaded template material obtained from step (a) is heated at about 100° C. and then at about 160° C. to remove moisture and volatiles therefrom. This process will also help to initiate polymerisation between the carbon and the heteroatom dopant precursors. In some exemplary embodiments, for step (b), the loaded template material obtained from step (a) is heated at about 100° C. for about 6 hours and then at about 160° C. for about 6 hours to remove moisture and volatiles therefrom.

In some embodiments, for step (c), the activating agent is selected from the group consisting of a zinc compound, phosphoric acid, potassium acetate, sodium hydroxide, potassium carbonate, ammonium carbonate, and ammonium persulfate. In some exemplary embodiments, the zinc compound is selected from the group consisting of ZnCl₂ and ZnO.

In some embodiments, for step (c), the activating agent and the natural halloysite-kaolin nanoclays are in a weight ratio of from about 1:6 to about 4:3. In some exemplary embodiments, the activating agent and the natural halloysite-kaolin nanoclays are in a weight ratio of about 2:3.

In some embodiments, for step (c), the activating agent is introduced as a dry solid to the composition.

In some embodiments, the loaded template material obtained from step (b) or the composition obtained from step (c) is subject to pulverisation before step (d). Pulverisation is typically required for solid state activation.

In some embodiments, for step (d), the composition obtained from step (c) is activated and carbonised at a temperature of about 600° C. to about 900° C. for about 5 hours. In some further embodiments, the composition obtained from step (c) is activated and carbonised at a temperature of about 800° C. for about 5 hours. In some embodiments, for step (d), the activation and carbonisation is conducted under an inert atmosphere, such as under an inert atmosphere.

In some embodiments, for step (e), the composition obtained from step (d) is treated with HCl to remove the activating agent and with HF to remove the template material.

In some embodiments of the second aspect, the doped activated nanoporous carbon material has a heteroatom content of from about 0.25% to about 15.00% by weight.

In some embodiments, the doped activated nanoporous carbon material has a nitrogen (N) content of from about 0.25% to about 15.00% by weight.

In some embodiments, the doped activated nanoporous carbon material has a sulfur (S) content of from about 0.30% to about 2.28% by weight and nitrogen (N) content of from about (9.25%) to 13.19%

In some embodiments, the doped activated nanoporous carbon material has boron (B) content and oxygen content of from about 11.10% to 26.92%

In some embodiments, the doped activated nanoporous carbon material has a specific capacitance of more than about 200 F/g at a current density of 0.3 A/g. In some embodiments, the doped activated nanoporous carbon material has a specific capacitance of about 299 F/g at a current density of 0.3 A/g. In some exemplary embodiments, the doped activated nanoporous carbon material has a specific capacitance of about 299 F/g, about 228 F/g and about 194 F/g at a current density of 0.3 A/g, 0.5 A/g, and 1 A/g.

In some embodiments, the doped activated nanoporous carbon material has a specific surface area of from about 1350 m²/g to about 1700 m²/g. In some further embodiments, the doped activated nanoporous carbon material has a specific surface area of from about 1500 m²/g to about 1700 m²/g. In some further embodiments, the doped activated nanoporous carbon material has a specific surface area of from about 1600 m²/g to about 1700 m²/g.

In some embodiments, the doped activated nanoporous carbon material has a pore volume of from about 1.0 cm³/g to about 1.6 cm³/g. In some further embodiments, the doped activated nanoporous carbon material has a pore volume of from about 1.3 cm³/g to about 1.6 cm³/g. In some further embodiments, the doped activated nanoporous carbon material has a pore volume of from about 1.4 cm³/g to about 1.6 cm³/g.

In some embodiments, the doped activated nanoporous carbon material has a specific area of about 1700 m²/g and a pore volume of about 1.465 cm³/g.

In some embodiments, the doped activated nanoporous carbon material has a CO₂ adsorption capacity of at least about 22.5 mmol/g when determined at 0° C. and 30 bar. In some further embodiments, the doped activated nanoporous carbon material has a CO₂ adsorption capacity of about 24.4 mmol/g when determined at 0° C. and 30 bar.

In a third aspect, the present disclosure provides use of the doped activated nanoporous carbon material of the first aspect or the doped activated nanoporous carbon material prepared by the method of the second aspect in an anode material for sodium-ion or lithium-ion batteries.

In a fourth aspect, the present disclosure provides use of the doped activated nanoporous carbon material of the first aspect or the doped activated nanoporous carbon material prepared by the method of the second aspect in an electrode material for supercapacitors.

In a fifth aspect, the present disclosure provides use of the doped activated nanoporous carbon material of the first aspect or the doped activated nanoporous carbon material prepared by the method of the second aspect in CO₂ adsorption.

In a sixth aspect, the present disclosure provides use of the doped activated nanoporous carbon material of the first aspect or the doped activated nanoporous carbon material prepared by the method of the second aspect for electrochemical energy storage and conversion.

In a seventh aspect, the present disclosure provides use of the doped activated nanoporous carbon material of the first aspect or the doped activated nanoporous carbon material prepared by the method of the second aspect for water/wastewater treatment.

In an eighth aspect, the present disclosure provides use of the doped activated nanoporous carbon material of the first aspect or the doped activated nanoporous carbon material prepared by the method of the second aspect in a fuel cell.

In a ninth aspect, the present disclosure provides use of the doped activated nanoporous carbon material of the first aspect or the doped activated nanoporous carbon material prepared by the method of the second aspect as a catalyst material for thermocatalytic and/or electrocatalytic reactions.

In a tenth aspect, the present disclosure provides use of the doped activated nanoporous carbon material of the first aspect or the doped activated nanoporous carbon material prepared by the method of the second aspect in a sensor such as an enzymatic biosensor.

In an eleventh aspect, the present disclosure provides use of the doped activated nanoporous carbon material of the first aspect or the doped activated nanoporous carbon material prepared by the method of the second aspect as an antimicrobial agent.

### DESCRIPTION OF FIGURES

FIG. 1 shows SEM images of natural halloysite-kaolin nanoclay samples from Streaky Bay with samples showing 1%, 70% and 99% halloysite: kaolinite natural admixtures.

FIG. 2 shows an illustrative synthesis process of doped activated nanoporous carbon material by use of natural halloysite-kaolin nanoclay as a template.

FIG. 3 shows FTIR spectra of N-doped activated nanoporous carbon materials carbonised at different temperatures (700, 800 and 900° C.) according to the present disclosure.

FIG. 4 shows the XPS survey and high-resolution spectra of a N-doped activated nanoporous carbon material carbonised at 800° C. according to the present disclosure.

FIG. 5 shows SEM images of an embodiment of the N-doped activated nanoporous carbon material which is carbonised at 700° C.

FIG. 6 shows SEM images of an embodiment of the N-doped activated nanoporous carbon material which is carbonised at 800° C.

FIG. 7 shows SEM images of an embodiment of the N-doped activated nanoporous carbon material which is carbonised at 900° C.

FIG. 8 shows the CO₂ adsorption isotherms of a) N-ANCx samples measured at a pressure range of 0-30 bar, and b) N-ANC₈₀₀ measured at three different temperatures 0, 10 and 25° C. and a common pressure range of 0 to 30 bar c) Isosteric heat of adsorption of N-ANCx samples calculated from adsorption isotherms obtained at three different temperatures of 0, 10 and 25° C. and d) Comparison of N-ANC₈₀₀ with the K-HNT and other porous carbon materials: HNC— Porous carbon derived from K-HNT; N-HNC₈₀₀— N doped porous carbon derived from K-HNT without activation.

FIG. 9 shows cyclic voltammograms (CV) of the samples measured between the scan rate range of 5-100 mV s⁻¹ (a) N-ANC₇₀₀ (c) N-ANC₈₀₀ and (e) N-ANC₉₀₀; Galvanostatic charge/discharge (GCD) measurements of N-ANCx samples measured at different current densities in the range of 0.3 to 10 A g⁻¹ (b) N-ANC₇₀₀ (d) N-ANC₈₀₀ and (f) N-ANC₉₀₀.

FIG. 10 shows specific capacitance data of N-ANCx (a) Cyclic voltammograms (CV) of the samples measured at scan rate-10 mV s⁻¹ (b) Galvanostatic charge/discharge (GCD) measurements of N-ANCx samples measured at the current density of 1 A g⁻¹ (c) The Nyquist plot of N-ANCx samples measured at 0.1 hz and (d) Specific capacitance value (Cs) of N-ANCx samples measured at various current densities.

FIG. 11 shows Galvanostatic charge/discharge (GCD) measurements of B-ANCx samples measured at different current densities 0.5 A g⁻¹ and cyclic voltammograms (CV) of the samples measured at the scan rate range of 10 mV s⁻¹

FIG. 12 shows charge and discharge capacity profiles at 1^{st}, 2^{nd}, 5^{th}, 50^{th} cycles at a current density of 100 mAh g⁻¹.

### DETAILED DESCRIPTION

The term “nanoporous” used herein means the size of the pores being generally 100 nanometers or less.

The term “activated”, when referring to carbon material in the present disclosure, means the carbon material has been processed to demonstrate small, low-volume pores that increase the surface area available for adsorption or ion transport.

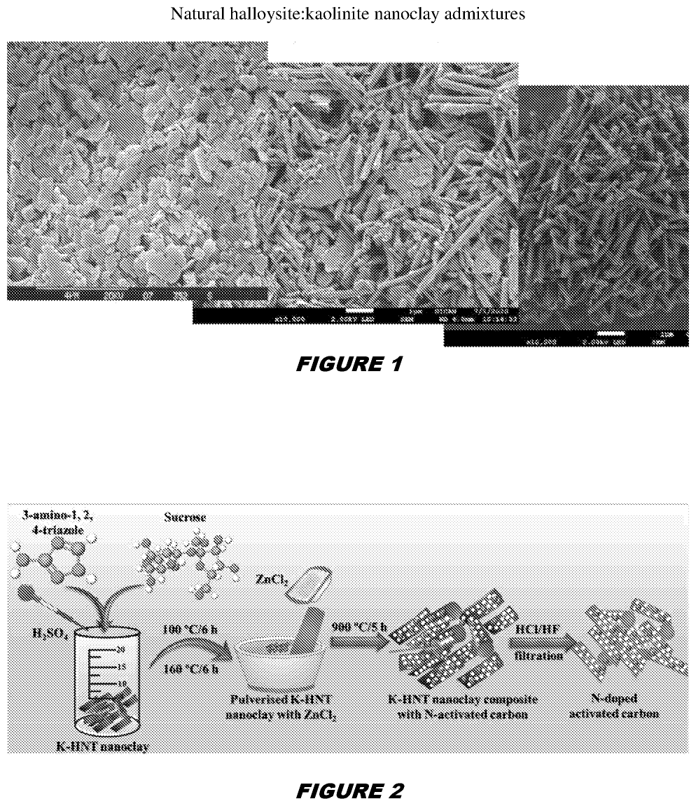

The phrase “natural halloysite-kaolin nanoclay” used herein refers to a low-cost and naturally available clay material that can be used with or without purification. Examples of these materials are shown in FIG. 1. The natural halloysite-kaolin nanoclay is a hybrid blend of halloysite Al₂Si₂O₅(OH)₄-2H₂O and kaolinite Al₂Si₂O₅(OH)₄ clay minerals. Kaolinite has the formula Al₂Si₂O₅(OH)₄ and typically occurs in platy forms. Halloysite has a similar composition to kaolinite except that it contains additional water molecules between the layers and exhibits a nanotubular morphology. Halloysite may lose its interlayer water very easily and be present in a partly dehydrated state. The halloysite presents as long tubes with large lumen, wherein the lumen is the inside of the tube just like the inside of straw. For instance, the natural halloysite-kaolin nanoclays are readily available in the western region of South Australia. FIG. 1 depicts SEM images of natural halloysite-kaolin nanoclay samples from deposits in western South Australia. The natural halloysite-kaolin nanoclays to be used herein may contain variable ratios of halloysite and kaolinite, but generally more than about 40% halloysite nanotubes, and up to greater than about 80% halloysite nanotubes. Kaolinite, once exfoliated, has a flake-like structure which is beneficial, in conjunction with halloysite nanotubes, to synthesize the N-doped porous carbon with a flake like structure. In other words, the flake-like structure of the kaolinite is replicated into the N-doped activated nanoporous carbon during carbonization procedure together with the nanotubular structure of the halloysite. The flake-like structure of the N-doped activated nanoporous carbon offers additional channels for a faster diffusion/transport of ions during electrochemical operation or adsorption of gases. Moreover, the availability of natural halloysite-kaolin nanoclays as a template offers additional advantages of low-cost and abundancy as compared to conventional templates such as silica.

The present invention arises from the inventors' findings that halloysite-kaolin nanoclays with a mixture of flaky and tubular morphology can serve as a template which allows for the morphological features thereof to be replicated into carbon material and that it is possible to adopt a simple solid state single step activation coupled with templating process to fabricate N-doped activated nanoporous carbon material with desirable performances in specific capacitance, CO₂ adsorption, charge and discharge capacity.

Carbon hosts can be modified by doping with heteroatoms such as phosphorus, boron, sulphur and nitrogen. It is believed that introduction of nitrogen will improve the electron density of the carbon framework or increase the basicity of the carbon framework which in turn will anchor the electron deficient carbon of the CO₂ to the carbon pore surface by Lewis-acid/Lewis-base (N atom) interactions.

However, it has been difficult to control nitrogen functionalities on the surface of nanoporous carbon material. Post-treatment approach generally involves a complex process and use of toxic nitrogen precursors such as ammonia or melamine. Also, porous carbon material treated with N-containing precursors such as ammonia and melamine are less favourable for controlling the dopant distribution and the porosity. In addition, post-treatment approach can easily make porous structure collapsed. In contrast to the post-treatment approach, the templating strategy is now adopted widely for synthesis of ordered heteroatom doped porous carbon with heteroatom containing carbon precursors or mixing them with other carbon sources. It is also possible to control nitrogen content in the final material though this approach without toxic precursors/gases. Nonetheless, it is still challenging to develop an effective strategy to fabricate heteroatom doped porous carbons with both a large surface area and high heteroatom doping.

It has been found by the present inventors that the processes disclosed herein can be employed to functionalise the surface of the nanoporous carbon material, which has the benefit of enhanced application performance, such as for batteries. Furthermore, carbonization temperature can be used to tune the nitrogen content and the textural properties of the final products as they dictate the final performance in electrochemical and adsorption applications.

Accordingly, provided herein is a doped activated nanoporous carbon material prepared from a template material comprising natural halloysite-kaolin nanoclays, a carbon precursor, a heteroatom dopant precursor and an activating agent, wherein the doped activated nanoporous carbon material exhibits a flake and nanotubular morphology and bears surface heteroatom functionalities.

Also provided herein is a method of preparing a doped activated nanoporous carbon material, the method including:
(a) loading a template material comprising natural halloysite-kaolin nanoclays with a carbon precursor and a heteroatom dopant precursor;
(b) removing moisture and volatiles from the loaded template material obtained from step (a);
(c) producing a composition comprising the loaded template material obtained from step (b) and an activating agent;
(d) activating and carbonising the composition obtained from step (c) at a temperature of about 600° C. to about 900° C.; and
(e) removing the template material and the activating agent from the composition obtained from step (d).

Generally, the doped activated nanoporous carbon materials are prepared from the template material comprising natural halloysite-kaolin nanoclays through sacrificial hard templating and simple in-situ doping combined with activation. In some embodiments, the template material consists of natural halloysite-kaolin nanoclays.

Natural halloysite-kaolin nanoclays are of low-cost and naturally available, for example from western region of South Australia. For the purpose of the present disclosure, the halloysite-kaolin nanoclays can be used directly after being extracted and do not need purification. For example, the halloysite-kaolin nanoclays used herein is commercially available under ParlaWhite®.

It is possible to use a natural halloysite-kaolin nanoclays that contain more than about 40% halloysite nanotubes. In some embodiments, the natural halloysite-kaolin nanoclays contain more than about 80% halloysite nanotubes. It has been found that the natural halloysite-kaolin nanoclays acts as a template in the way that a flake like structure of kaolin can be replicated into the doped activated nanoporous carbon material as slit-like pores, and the tube walls of halloysite will be replicated into the doped activated nanoporous carbon material as a mesoporous structure. This mechanism is illustrated in FIG. 2.

Selection of the carbon precursor may take into account high carbon content, cost-effectiveness and readiness to undergo dehydration at a relatively lower temperature etc. In this context, the carbon precursor to be used herein can be a carbohydrate-based compound, such as a sugar-based compound, or mixtures thereof. Specifically, the sugar-based compound may include sucrose, glucose, fructose, and polysaccharides. If desired, the sugar-based compound may be sourced from materials such as waste fruit juice/pulp, and waste carbonated sugar containing beverages. Examples of the polysaccharides are, but not limited to, cellulose, chitosan and starch. In a preferable embodiment, sucrose is used as the carbon precursor. It is believed that thermal treatment of natural halloysite-kaolin nanoclay template with sucrose is helpful in establishing bonding between the outer surface of the nanoclay and sucrose molecules. This leads to coverage of the surface of the nanoclay with carbon originated from sucrose. Moreover, sucrose is a low cost, non-toxic, and abundantly available carbon precursor. Sucrose is commercially available, for example from Sigma-Aldrich with purity ≥99.5%. For preparing the doped activated nanoporous carbon material, the carbon precursor and the template material (for example, the natural halloysite-kaolin nanoclays) can be in a weight ratio of from about 2:10 to about 4:10, for example, 2:10, 2.5:10, 3:10, 3.5:10, and 4:10. In a preferable embodiment, the carbon precursor and the template material are in a weight ratio of about 3:10.

The heteroatom dopant can be any suitable atom that is not carbon or hydrogen. Non-limiting examples include, but are not limited to nitrogen (N), sulfur (S), oxygen (O) and boron (B). As used herein the term “dopant” means an impurity that is intentionally introduced into the intrinsic carbon framework for the purpose of modulating one or properties of the material, such as its electrical, optical or structural properties. For the purposes of the present disclosure, a distinction can be made between “doping” which involves incorporating a heteroatom into flaws in the carbon framework such that the heteroatom is intrinsically incorporated into the carbon framework and “loading” which involves loading a heteroatom into interstitial space(s) within the carbon framework. The person skilled in the art will appreciate that doping and loading result in different properties in the final material.

Any suitable heteroatom dopant precursor can be used. A nitrogen precursor with tightly bound nitrogen might not release nitrogen atoms for chemical reaction during thermal carbonisation, whereas a precursor that can easily donate nitrogen at a relatively lower temperature may be desirable for the present disclosure. Moreover, solid nitrogen containing precursors that are cost-effective, easy to handle, and contain high content of nitrogen as compared to liquid and gaseous nitrogen precursors are suitable for the purpose. The nitrogen precursor to be used herein can be a compound containing one or more nitrogen atoms. Non-limiting examples of the nitrogen precursor include aminoguanidine, aminoguanidine hydrochloride, aminotriazoles, urea, chitosan, cyanamide, dicyanamide, thiourea, melamine, casein, polyaniline, polypyrrole, aminotetrazoles, and aminotriazines. In some embodiments, the nitrogen precursor is an aminotriazole. In certain exemplary embodiments, the nitrogen precursor is 3-amino-1,2,4-triazole. The nitrogen precursor may be a compound containing one or more nitrogen atoms and one or more other heteroatoms, such as sulfur. Suitable nitrogen precursors in this regard include thiourea, thioacetamide, L-cysteine, methionine, dithiocarbamates, dithiooxamide, thiazoles such as 2-aminothiazole, 5-amino-1,3,4-thiadiazole-2-thiol, thiosemicarbazide, and thiocarbohydrazide.

A sulfur precursor can be used as the heteroatom dopant precursor in order to provide an S-doped activated nanoporous carbon material. The sulfur precursor may be a carbon compound containing one or more sulfur atoms such as diphenyl disulphide, polyphenylene sulfide, bis(trimethylsilyl) sulfide, alkyl thiol, and thiophene. The sulfur precursor may be an inorganic compound containing one or more sulfur atoms, such as sulphur powder, sodium sulphide, sodium dithionite, and sodium thiosulfate. Alternatively, the sulfur precursor may be a carbon containing compound containing one or more sulfur atoms and one or more other heteroatoms, such as nitrogen. For example, the sulfur precursor may be selected from the group consisting of thiourea, thioacetamide, L-cysteine, methionine, dithiocarbamates, dithiooxamide, thiazoles such as 2-aminothiazole, 5-amino-1,3,4-thiadiazole-2-thiol, thiosemicarbazide, and thiocarbohydrazide.

A boron precursor can be used as the heteroatom dopant precursor in order to provide a B-doped activated nanoporous carbon material. The boron precursor may be a compound containing one or more boron atoms such as boric acid, ammonia borane (borazane), diborane, trimethyl boron, colemanite, boron trioxide, trimethoxy borane, sodium borate, borax, sodium borohydride, dimeric diborazane, trimeric triborazane, boron trifluoride, boron trichloride, and phenyl borate.

An oxygen precursor can be used as the heteroatom dopant precursor in order to provide an 0-doped activated nanoporous carbon material. The oxygen precursor may be a compound containing one or more oxygen atoms such as boric acid, boron trioxide, sodium borate, and borax.

The heteroatom dopant precursor may be a sulfur and nitrogen precursor such as thiourea, thioacetamide, L-cysteine, methionine, dithiocarbamates, dithiooxamide, thiazoles such as 2-aminothiazole, 5-amino-1,3,4-thiadiazole-2-thiol, thiosemicarbazide, and thiocarbohydrazide.

The heteroatom dopant precursor may be a boron and an oxygen precursor such as boric acid, boron trioxide, sodium borate, and borax.

The amount of the heteroatom dopant precursor is varied based on the specific surface area and the pore volume of the halloysite templates and the purity of the template. In some embodiments, the heteroatom dopant precursor and the template material (for example, the natural halloysite-kaolin nanoclays) are in a weight ratio of about 1:12 to about 1:4. In some exemplary embodiments, the heteroatom dopant precursor and the template material are in a weight ratio of about 1:10.

For step (a), the heteroatom dopant precursor and the carbon precursor can be loaded onto the template material in various ways, for example through impregnation. To this end, a solution of the carbon precursor and a solution of the heteroatom dopant precursor are prepared separately to impregnate the template material. Preferably, a solution of the carbon precursor in water and a solution of the heteroatom dopant precursor in water are prepared separately and then added dropwise to the template material. The amount of water used is optimised to allow perfect diffusion of the carbon precursor and the heteroatom dopant precursor within the template material as addition of too much water may form the polymerized carbon material on the external surface of the templates but not too much to be removed during subsequent step (b). In certain of these embodiments, the water used to prepare the solutions and the template material (for example, the natural halloysite-kaolin nanoclays) are in a weight ratio of from about 1:1 to about 2:1. In some exemplary embodiments, the water used to prepare the solutions and the template material is in a weight ratio of about 4:3.

The amount of water used is optimised in order to achieve the perfect diffusion of the precursors within the nanochannels of the template material, especially the natural halloysite-kaolin nanoclays. In some embodiments, the ratio of the precursors (i.e. carbon precursor+nitrogen precursor) and water is in the range of about 1:2.5 to about 1:6 by weight, preferably about 12:40 by weight. Preferably, a dehydration agent is also applied onto the template material. This can be achieved by introducing the dehydration agent into the aqueous solution of the sugar-based compound. Suitable dehydration agents include, but not limited to, sulphuric acid, formic acid, acetic acid and citric acid. The amount of the dehydration agent to be used would be readily determined by the amount of the carbon and nitrogen precursors used in the template.

The present disclosure employs an in-situ doping approach wherein the carbon precursor and the heteroatom dopant precursor are combined before thermal treatment, which is believed to be advantageous over a post-treatment approach wherein the heteroatom dopant precursor is added to already carbonised porous carbon. This is because the former allows a uniform distribution of heteroatoms over the porous carbon whereas the latter may destroy the structure of the carbon precursors, resulting in alteration to the pore size and morphology.

In addition, it is suggested to further load the template material with a dehydration agent in order to assist with dehydration of the carbon precursor. For example, the dehydration agent can be added into the solution of the carbon precursor for impregnation. The dehydration agent used herein may include sulfuric acid and organic acids such as formic acid, acetic acid or citric acid. The amount of carbon and heteroatom dopant precursors added in the template material of the dehydration agent might have benefits of increasing the mass yield of carbon after carbonisation and reducing sample shrinkage during carbonisation.

If needed, the loaded template material formed from the template material, the carbon precursor, the heteroatom dopant precursor and other components such as the dehydration agent (if present) can then be thoroughly mixed.

Moisture and volatiles are to be removed from the loaded template material obtained without significant decomposition through heating at 100 C for 6 h and then 160 C for 6 h. This process will also help to initiate the polymerization between the carbon and the heteroatom dopant precursors. For this purpose, the loaded template material obtained from step (a) can be subject to low-temperature heat treatment, for example with the aid of a hot air oven or a vacuum oven. In some embodiments, for step (b), the loaded template material is heated at about 100° C. and then at about 160° C. In some exemplary embodiments, for step (b), the loaded template material is heated at about 100° C. for about 6 hours and then at about 160° C. for about 6 hours.

In order to concurrently perform activation and carbonisation, the loaded template material and an activating agent will be combined. The combined use of the heteroatom dopant precursor and the activating agent significantly enlarges pore diameter of the final product.

The type of the activating agent can be used to control the nature of porosity in the doped activated nanoporous carbon material. In some embodiments, the activating agent is selected from a zinc compound, phosphoric acid, potassium acetate, sodium hydroxide, potassium carbonate, ammonium carbonate, and ammonium persulfate. In some exemplary embodiments, the zinc compound can be selected from ZnCl₂ and ZnO. The amount of the activating agent plays a role in achieving some properties of the activated doped nanoporous carbon material, such as surface area, microporous area and micropore volume. In some embodiments, the activating agent and the template material (for example, the natural halloysite-kaolin nanoclays) are in a weight ratio of from about 1:6 to about 4:3. In some exemplary embodiments, the activating agent and the template material are in a weight ratio of about 2:3.

The activating agent can be combined with the loaded template material in dry state or in solid state. In a preferable embodiment, the activating agent in a dry solid form is combined with the loaded template material for step (c). If need be, the loaded template material that has been treated as previously discussed can be pulverised into fine powder before combining with the loaded template material. The solid state procedure has been demonstrated to be more favourable for producing carbon materials with better features than the liquid state or where soaking of the precursors in the solution of activating agent is involved. The solid state procedure also eliminates the need for an additional step of evaporating the solution to dryness before high temperature carbonisation.

It is worth mentioning that activation and carbonisation are performed concurrently for the present disclosure, which makes the preparation process simple and cost effective. The combined procedure of activation and carbonisation eliminate the time requirements required for a conventional two step procedure. This is a more favourable procedure in lieu of the considerations such as energy spent for the process and the manpower.

The composition prepared as stated above comprises the template material, the carbon precursor, the heteroatom dopant precursor, the activating agent and, if present, other components such as the dehydration agent and will then be subject to activation and carbonisation at a temperature of about 600° C. to about 900° C. for step (d). The activation and carbonisation can be carried out under inert atmosphere, for example nitrogen atmosphere. In some embodiments, the composition is activated and carbonised at a temperature of about 600° C. to about 900° C. for about 5 hours. Preferably, the composition is activated and carbonised at a temperature of about 800° C. It is believed that diminished textural features can be minimised and the activating agent can exert full effect at a temperature of about 800° C.

The activation and carbonisation process starts with polymerisation of the carbon chains. These carbon chains may undergo breakage, reformation, further polymerisation, aromatisation and so on, which ultimately results in production of the doped activated nanoporous carbon around the nanoclays. The nanoclays themselves may undergo rearrangement of atoms/partial collapse of structure, but it is surmised that there will not be too much effect on their structure. During carbonisation, the carbon precursor enters the empty lumen of the available tubular structures to replicate the tube structures in carbons.

After being activated and carbonised, the template material and the activating agent are required to be removed from the composition. The activating agent may be removed by washing with HCl or water, for example by using a 2M HCl solution. The template material may be removed by washing with HF, for example by using a dilute HF solution. It is preferable to rinse the composition with water (for example, distilled water) after HCl treatment in order to completely remove the activating agent. In some embodiments, the activated and carbonised composition is washed with a HCl solution (for instance, 2 hours) and then rinsed with water, after which the composition is washed with a dilute HF solution (for instance 5 wt %). This may be followed by filtration and washing with excess ethanol and then drying so as to remove most of the impurities from the doped activated nanoporous carbon material.

Various features such as elemental composition, morphology, specific capacitance, specific surface, pore volume, and charge and discharge profiles can be used to characterise the doped activated nanoporous carbon material obtained as stated above.

In the following discussion, reference will be made to N-doped materials for illustration purposes only. Other heteroatom doped materials could also be used and tested, including S-doped activated nanoporous carbon materials and B-doped activated nanoporous carbon material as required.

### Elemental Composition

The elemental composition of N-doped activated nanoporous carbon materials can be estimated with a CHNS/O elemental analyser. Elemental analysis of the N-doped activated nanoporous carbon materials shows that carbonisation temperature strongly affects the carbon and nitrogen content of the final material. The carbon and nitrogen content are different for the materials carbonised at different temperatures. Nitrogen content in the carbon frameworks gradually decreases with increasing carbonisation temperature from 600 to 900° C. because the high temperature can cause the evaporation of nitrogen species. However, the Nitrogen content (˜10%) in the carbon framework of the materials carbonised at 800° C. is relatively higher than the other N doped materials reported so far (Zhou et al. 2018; Lu et al. 2017; Kim et al. 2019; Zou et al. 2019).

In some embodiments, the N-doped activated nanoporous carbon material has a nitrogen content of from about 0.25% to about 15.00% by weight.

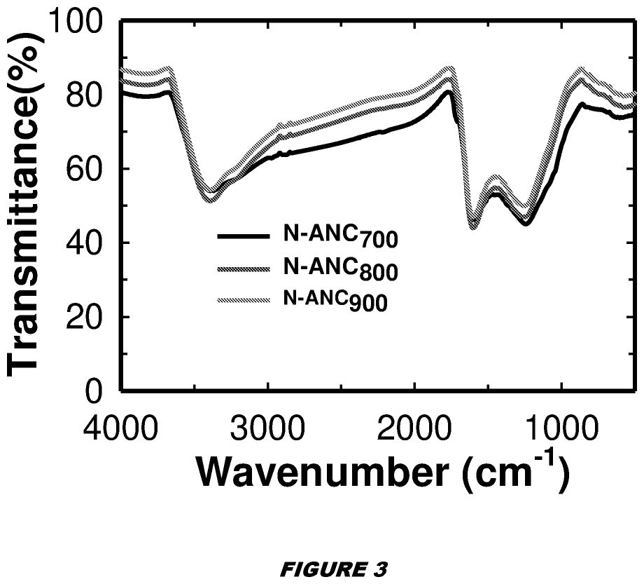

FIG. 3 shows FTIR spectra of N-doped nanoporous carbon materials synthesised at different temperatures (600, 700, 800 and 900° C.). Nitrogen in the forms of C═N boding (at −1600 cm⁻¹) and N—H bonding (at ˜1300 cm⁻¹) are clearly observed on the surface of the material samples. It is believed that the homogeneous N-doping into the porous carbon frameworks plays a role in the exceptional performance of the N-doped activated nanoporous carbon materials disclosed herein as it enhances wettability in an aqueous solution and offers redox sites. Furthermore, nitrogen functionalities on the surface enhance the surface charge and the wettability and thereby promote the performance in carbon capture and energy storage.

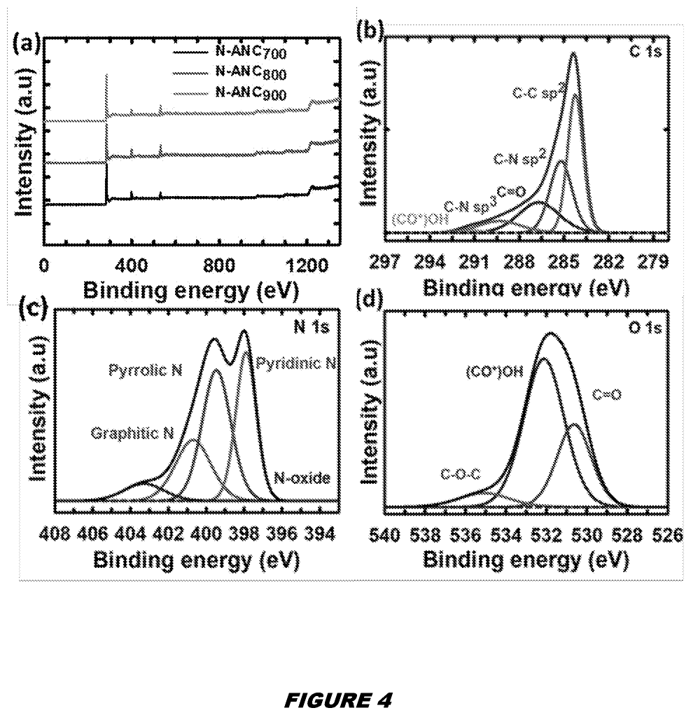

High temperature nitrogen species such as quaternary nitrogen and pyridine-N-oxide are found on the surface of the N-doped activated nanoporous carbon materials, which may be due to the high activation temperature used in the process disclosed herein. This can be seen from FIG. 4. The amount of nitrogen can be controlled by adjusting the carbonization temperature as thermodynamic stability of N in the carbon materials is very low.

### Morphology

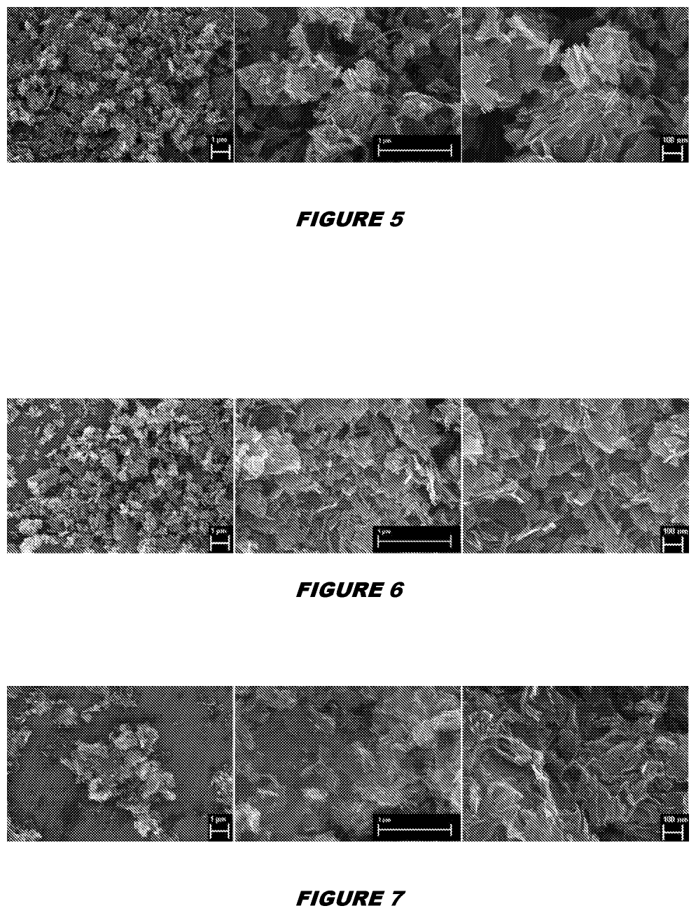

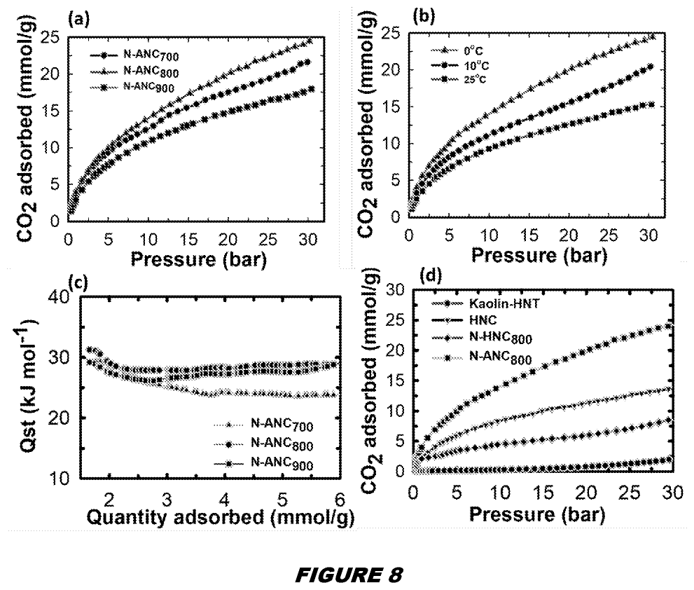

Morphological analysis can be conducted using FE-SEM and HRTEM. It is observed from FIGS. 5 to 7 that the morphology of the material disclosed herein exhibited a sheet like structure with porosity, which is made up of numerous uniformly-distributed flaky and tube-like particles. These reveal that the morphological features of the template are replicated into the N-doped activated nanoporous carbon material. The N-doped activated porous carbon material carbonised at 900° C. showed an aggregated form of flaky-sheet like morphology (see, for example, FIG. 7). It is assumed that they agglomerated together at a high temperature through simple siloxane bridges.

### CO₂ Adsorption Capacity

Micromeritics HPVA instrument equipped with a temperature-controlled circulator can be used to measure high-pressure CO₂ adsorption capacity of the N-doped activated nanoporous carbon material disclosed herein. A pressure range of 0-30 bar was used to record the adsorption isotherms at a temperature of 0° C., 10° C. and 25° C. Prior to analysis, samples were degassed under constant vacuum for 12 hours at a temperature of 200° C. The results from the CO₂ adsorption isotherm shown in FIG. 8(d) suggest that the N-doped activated nanoporous carbon material disclosed herein exhibit superior CO₂ adsorption capacity as compared to the carbon materials without doping or activation. From the adsorption isotherm, it can be observed that the N-doped activated nanoporous carbon material disclosed herein depicts an initial steep increase in the CO₂ adsorption followed by a linear increase at high pressure (the pressure between 5 and 30 bar). This clearly demonstrates the robustness of the porous structure of the N-doped activated nanoporous carbon material that does not collapse even at a higher pressure of 30 bar. In the low-pressure regime, the active microporous sites at the surface are filled first, and as the pressure increases, CO₂ molecules also fill the inner mesoporous centres of the carbon structures.

In some embodiments, the N-doped activated nanoporous carbon material has a CO₂ adsorption capacity of at least about 22.5 mmol/g when determined at 0° C. and 30 bar. In some further embodiments, the N-doped activated nanoporous carbon material has a CO₂ adsorption capacity of about 24.4 mmol/g when determined at 0° C. and 30 bar. It is obvious from FIG. 8 that the CO₂ adsorption capacity of the N-doped activated nanoporous carbon material is higher than that of the non-activated porous carbon material without N doping (about 13.1 mmol/g). At low pressure of ˜1 bar, the adsorption capacity of the N-doped activated nanoporous carbon material is about 3.9 mmol/g which is relatively better than the non-activated nanoporous carbon material without N doping (about 2.4 mmol/g). The CO₂ adsorption of N-ANCx was compared with the nitrogen functionalised mesoporous carbons, N-doped activated carbon, and mesoporous carbon nitrides (Table 2). The data revealed that N-ANCx has high CO₂ adsorption capacity than the compared materials owing to its superior textural properties and nitrogen doping.

The specific surface area and pore volume of the material are analysed by measuring the N₂ adsorption and desorption isotherms at −196° C. The measurement can be carried out with micromeritics ASAP 2420 surface area and porosity analyser. The specific surface area can be determined by utilising the Brunauer-Emmett-Teller (BET) model. The N-doped activated nanoporous carbon material disclosed herein possesses a specific surface area in the range of from about 1350 m²·g⁻¹ to about 1700 m²·g⁻¹. In some embodiments, the N-doped activated nanoporous carbon material has a specific surface area of from about 1500 m²·g⁻¹ to about 1700 m²·g⁻¹, preferably from about 1600 m²·g⁻¹ to about 1700 m²·g⁻¹. In addition or alternatively, the N-doped activated nanoporous carbon material disclosed herein has a pore volume of from about 1.000 cm³/g to about 1.600 cm³/g. In some embodiments, the N-doped activated nanoporous carbon material has a specific surface area of from about 1.300 cm³/g to about 1.600 cm³/g, preferably from about 1.400 cm³/g to about 1.600 cm³/g. In a preferable embodiment, the N-doped activated nanoporous carbon material disclosed herein displays a specific surface area about 1700 m²·g⁻¹ and a pore volume of about 1.465 cm³/g. It is believed that a higher surface area and a relatively higher pore volume significantly contribute to the higher CO₂ adsorption capacity. In addition, the high degree of surface functional groups further contributes to the higher CO₂ adsorption capacity.

The CO₂ adsorption properties of N-ANC and other reported porous carbon materials are shown in Table 1.

TABLE 1
Comparison of the performances of the N-ANC and other reported
porous carbon materials as CO₂ high-pressure solid adsorbents.

| | BET | | | |
|---|---|---|---|---|
| | Surface | CO₂ | | |
| | area | adsorption | Testing | |
| Sample Code | (m² g⁻¹) | (mmol g⁻¹) | conditions | References |
| N-ANC-800 | 1695 | 24.4 | 0° C. and | This work |
| | | | 30 bar | |
| N-ANC-700 | 1571 | 20.1 | 0° C. and | This work |
| | | | 30 bar | |
| CPC-3 | 2212 | 25.4 | 0° C. and | Singh et al 2021 |
| | | | 30 bar | |
| Ordered | 655 | 15.4 | 0° C. and | Singh et al 2017 |
| mesoporous | | | 30 bar | ACS Appld. |
| carbon nitrides | | | | Mater. |
| | | | | Interfaces |
| N-doped | 1863 | 18.2 | 0° C. and | Singh et al 2017, |
| activated | | | 30 bar | J. Mater. |
| carbon | | | | Chem. A |
| N-doped | 959 | 18.2 | 0° C. and | Zhou et al 2015 |
| ordered | | | 30 bar | |
| mesoporous | | | | |
| carbon | | | | |
| N-doped porous | 2309 | 19.4 | 0° C. and | Li and Cao 2015 |
| carbon | | | 30 bar | |
| N-HPC | 1960 | 29 | 0° C. and | Wang et al. 2019 |
| | | | 30 bar | |
| G-3.6-1 | 3470 | 31.9 | 0° C. and | Sevilla et al. 2018 |
| | | | 30 bar | |

Note that CPC-3 is sasein derived porous carbon; N-HPC is N-doped hierarchically porous carbon derived from dicyandiamide and phenloic resin; and G-3.6-1 is N-doped activated porous carbon derived from glucose and potassium oxalate and melamine.

### Specific Capacitance/Charging and Discharging Profiles

The specific capacitance of the activated porous carbon derived from halloysite nanotubes without N-doping (AHNC) (see Kavitha Ramadass; C. L. Sathish; Sujanya MariaRuban; Gopalakrishnan Kothandam; Stalin Joseph; Gurwinder Singh; Sungho Kim; Wangsoo Cha; Ajay Karakoti; Tony Belperio; Jia Bao Yi; and Ajayan Vinu. Carbon Nanoflakes and Nanotubes from Halloysite Nanoclays and their Superior Performance in CO₂ Capture and Energy Storage. ACS Applied Materials & Interfaces 2020 12 (10), 11922-11933) is relatively less than that of the N-doped activated nanoporous carbon material disclosed herein. Specifically, the N-doped activated nanoporous carbon material carbonised at 800° C. exhibits a specific capacitance of about 299 F/g at a current density of 0.3 A/g, which is higher than that of AHNC (about 192 F/g). This means the N-doped activated nanoporous carbon material disclosed herein can store higher energy compared to the AHNC and thus suggests its high potential as a supercapacitor electrode material. In some embodiments, the N-doped activated nanoporous carbon material disclosed herein can have a specific capacitance of more than about 200 F/g at a current density of 0.3 A/g. In some further embodiments, the N-doped activated nanoporous carbon material has a specific capacitance of about 299 F/g at a current density of 0.3 A/g. In some exemplary embodiments, the N-doped activated nanoporous carbon material has a specific capacitance of about 299 F/g, about 228 F/g, about 194 F/g at a current density of 0.3 A/g, 0.5 A/g, and 1 A/g.

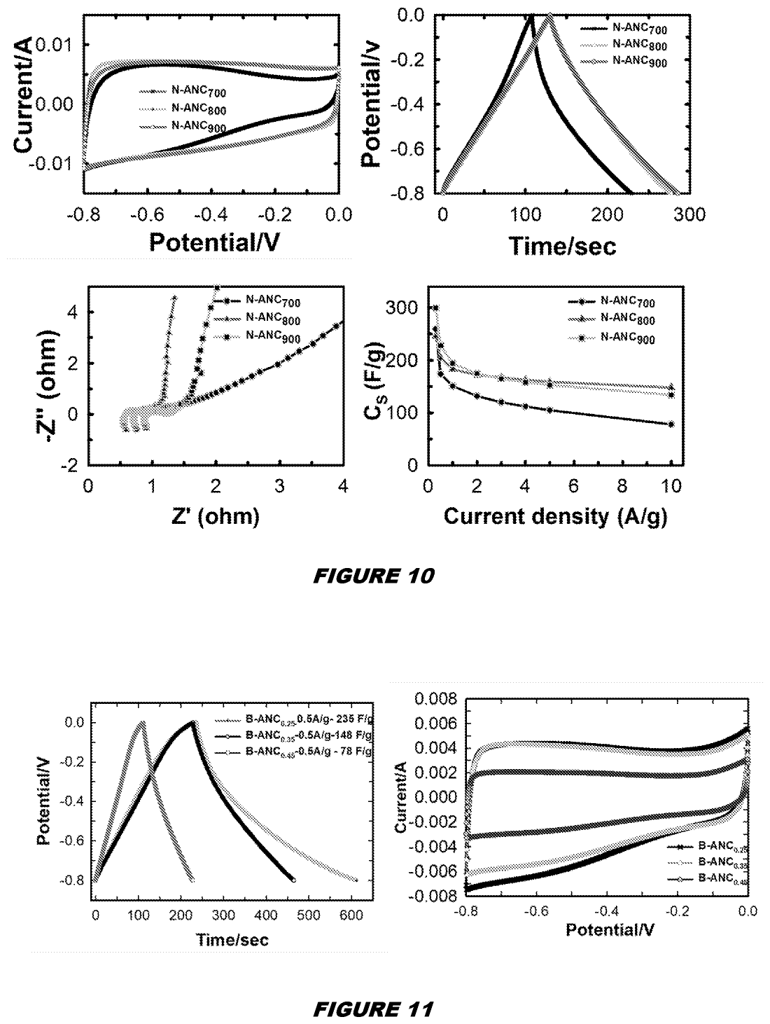

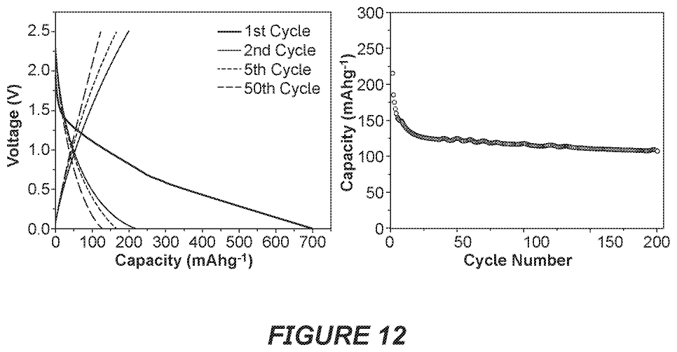

The electrical conductivity, specific surface area, large pore volume and surface nitrogen functionalities of the N-doped activated nanoporous carbon materials disclosed herein facilitate efficient ion/electron transport, which provides more Na⁺ storage sites. The N-doped activated nanoporous carbon material disclosed herein also displays a good charge-storing ability even at a scan rate as high as 100 mV/s (see, for example, FIG. 10) and demonstrates good cyclic stability (see, for example, FIG. 11). Specifically, such electrode shows promising capacitance retention after 200 cycles measured at 0.1 A/g. As a result of these properties, the N-doped activated nanoporous carbon materials disclosed herein are well suited for high performance sodium-ion or lithium-ion batteries.

It has been found that stabilization of electrochemical properties occurs more quickly for the N-doped activated nanoporous carbon materials than for nitrogen-free activated nanoporous carbon samples, as shown in Table 2.

TABLE 2
Comparison of Supercapacitance values of the N-ANC₉₀₀
with the already reported materials

| | Capacitance | Electrolyte and | |
|---|---|---|---|
| Sample Code | (F g⁻¹) | Current density | References |
| N-ANC₉₀₀ | 299 | 0.3 A g⁻¹, 3M KOH | This work |
| N-ANC₉₀₀ | 228 | 0.5 A g⁻¹, 3M KOH | This work |
| N-ANC₉₀₀ | 194 | 1.0 A g⁻¹, 3M KOH | This work |
| NCNFs | 193 | 1.0 A g⁻¹, 3M KOH | Zhao et al. |
| | | | 2019 |
| CPC-3 | 177 | 0.5 A g⁻¹, 3M KOH | Singh et al. |
| | | | 2021 |
| CP-NA | 148 | 0.5 A g⁻¹, 3M KOH | Choi et al. |
| | | | 2019 |

Note that NCNFs are nitrogen-doped carbon nanofibres; CPC-3 is casein derived porous carbon; and CP-NA is coffee waste derived nitrogen-doped carbon.

It will be evident from the foregoing description and the following examples that provided herein is a doped activated nanoporous carbon material prepared from a template material comprising natural halloysite-kaolin nanoclays, a carbon precursor, a heteroatom dopant precursor and an activating agent, wherein the doped activated nanoporous carbon material exhibits a flake and nanotubular morphology and bears surface heteroatom functionalities.

In specific embodiments, the template material consists of natural halloysite-kaolin nanoclays.

In specific embodiments, the the natural halloysite-kaolin nanoclays contain more than 40% by weight of halloysite nanotubes.

In specific embodiments, the natural halloysite-kaolin nanoclays contain more than 80% by weight of halloysite nanotubes.

In specific embodiments, the carbon precursor is a carbohydrate-based compound.

In specific embodiments, the carbon precursor is selected from sugar-based compounds.

In specific embodiments, the sugar-based compound is selected from the group consisting of sucrose, glucose, fructose, and polysaccharides.

In specific embodiments, the polysaccharides are selected from the group consisting of cellulose, chitosan and starch.

In specific embodiments, the heteroatom dopant precursor is a compound containing a plurality of heteroatoms.

In specific embodiments, the heteroatom dopant precursor is selected from one or more of the group consisting of a nitrogen precursor, a sulfur precursor, a boron precursor and an oxygen precursor.

In specific embodiments, the nitrogen precursor is selected from the group consisting of aminoguanidine, aminoguanidine hydrochloride, aminotriazoles, urea, chitosan, cyanamide, dicyanamide, thiourea, melamine, casein, polyaniline, polypyrrole, aminotetrazoles, and aminotriazines.

In specific embodiments, the nitrogen precursor is an aminotriazole.

In specific embodiments, the nitrogen precursor is 3-amino-1,2,4-triazole.

In specific embodiments, the sulfur precursor is selected from one or more of the group consisting of diphenyl disulphide, polyphenylene sulfide, bis(trimethylsilyl) sulfide, alkyl thiol, thiophene, sulphur powder, sodium sulphide, sodium dithionite, sodium thiosulfate, thiourea, thioacetamide, L-cysteine, methionine, dithiocarbamates, dithiooxamide, thiazoles such as 2-aminothiazole, 5-amino-1,3,4-thiadiazole-2-thiol, thiosemicarbazide, and thiocarbohydrazide.

In specific embodiments, the boron precursor is selected from one or more of the group consisting of boric acid, ammonia borane (borazane), diborane, trimethyl boron, colemanite, or boron trioxide, trimethoxy borane, sodium borate, borax, sodium borohydride, dimeric diborazane, trimeric triborazane, boron trifluoride, boron trichloride, and phenyl borate.

In specific embodiments, the oxygen precursor is selected from one or more of the group consisting of boric acid, boron trioxide, sodium borate, and borax.

In specific embodiments, the heteroatom dopant precursor is a sulfur and nitrogen precursor such as thiourea, thioacetamide, L-cysteine, methionine, dithiocarbamates, dithiooxamide, thiazoles such as 2-aminothiazole, 5-amino-1,3,4-thiadiazole-2-thiol, thiosemicarbazide, and thiocarbohydrazide.

In specific embodiments, the heteroatom dopant precursor is a boron and an oxygen precursor such as boric acid, boron trioxide, sodium borate, and borax.

In specific embodiments, the activating agent is selected from the group consisting of a zinc compound, phosphoric acid, potassium acetate, sodium hydroxide, potassium carbonate, ammonium carbonate, and ammonium persulfate.

In specific embodiments, the zinc compound is selected from the group consisting of ZnCl₂ and ZnO.

In specific embodiments, the doped activated nanoporous carbon material has a heteroatom content of from about 0.25% to about 15.00% by weight.

In specific embodiments, the doped activated nanoporous carbon material has a specific capacitance of more than about 200 F/g at a current density of 0.3 A/g.

In specific embodiments, the doped activated nanoporous carbon material has a specific capacitance of about 299 F/g at a current density of 0.3 A/g.

In specific embodiments, the doped activated nanoporous carbon material has a specific capacitance of about 299 F/g, about 228 F/g and about 194 F/g at a current density of 0.3 A/g, 0.5 A/g, and 1 A/g.

In specific embodiments, the doped activated nanoporous carbon material has a specific surface area of from about 1350 m²/g to about 1700 m²/g.

In specific embodiments, the doped activated nanoporous carbon material has a specific surface area of from about 1500 m²/g to about 1700 m²/g.

In specific embodiments, the doped activated nanoporous carbon material has a specific surface area of from about 1600 m²/g to about 1700 m²/g.

In specific embodiments, the doped activated nanoporous carbon material has a pore volume of from about 1.000 cm³/g to about 1.600 cm³/g.

In specific embodiments, the doped activated nanoporous carbon material has a pore volume of from about 1.300 cm³/g to about 1.600 cm³/g.

In specific embodiments, the doped activated nanoporous carbon material has a pore volume of from about 1.400 cm³/g to about 1.600 cm³/g.

In specific embodiments, the doped activated nanoporous carbon material has a CO₂ adsorption capacity of at least about 22.5 mmol/g when determined at 0° C. and 30 bar.

In specific embodiments, the doped activated nanoporous carbon material has a CO₂ adsorption capacity of about 24.4 mmol/g when determined at 0° C. and 30 bar.

It will be evident from the foregoing description and the following examples that provided herein is a method of preparing a doped activated nanoporous carbon material, which includes the following steps:
(a) loading a template material comprising natural halloysite-kaolin nanoclays with a carbon precursor and a heteroatom dopant precursor;
(b) removing moisture and volatiles from the loaded template material obtained from step (a);
(c) producing a composition comprising the loaded template material obtained from step (b) and an activating agent;
(d) activating and carbonising the composition obtained from step (c) at a temperature of about 600° C. to about 900° C.; and
(e) removing the template material and the activating agent from the composition obtained from step (d).

In specific embodiments, the template material consists of natural halloysite-kaolin nanoclays.

In specific embodiments, the natural halloysite-kaolin nanoclays contain more than 40% by weight of halloysite nanotubes.

In specific embodiments, the natural halloysite-kaolin nanoclays contain more than 80% by weight of halloysite nanotubes.

In specific embodiments, for step (a), the carbon precursor is a carbohydrate-based compound.

In specific embodiments, the carbohydrate-based compound is a sugar-based compound.

In specific embodiments, the sugar-based compound is selected from the group consisting of sucrose, glucose, fructose, and polysaccharides.

In specific embodiments, the polysaccharides are selected from the group consisting of cellulose, chitosan and starch.

In specific embodiments, for step (a), the heteroatom dopant precursor is a carbon compound containing a plurality of heteroatoms.

In specific embodiments, the heteroatom dopant precursor is selected from one or more of the group consisting of a nitrogen precursor, a sulfur precursor, a boron precursor and an oxygen precursor.

In specific embodiments, the nitrogen precursor is selected from the group consisting of aminoguanidine, aminoguanidine hydrochloride, aminotriazoles, urea, chitosan, cyanamide, dicyanamide, thiourea, melamine, casein, polyaniline, polypyrrole, aminotetrazoles, and aminotriazines.

In specific embodiments, the nitrogen precursor is selected from aminotriazoles.

In specific embodiments, the nitrogen precursor is 3-amino-1,2,4-triazole.

In specific embodiments, the sulfur precursor is selected from one or more of the group consisting of diphenyl disulphide, polyphenylene sulfide, bis(trimethylsilyl) sulfide, alkyl thiol, thiophene, sulphur powder, sodium sulphide, sodium dithionite, sodium thiosulfate, thiourea, thioacetamide, L-cysteine, methionine, dithiocarbamates, dithiooxamide, thiazoles such as 2-aminothiazole, 5-amino-1,3,4-thiadiazole-2-thiol, thiosemicarbazide, and thiocarbohydrazide.

In specific embodiments, the boron precursor is selected from one or more of the group consisting of boric acid, ammonia borane (borazane), diborane, trimethyl boron, colemanite, or boron trioxide, trimethoxy borane, sodium borate, borax, sodium borohydride, dimeric diborazane, trimeric triborazane, boron trifluoride, boron trichloride, and phenyl borate.

In specific embodiments, the oxygen precursor is selected from one or more of the group consisting of boric acid, boron trioxide, sodium borate, and borax.

In specific embodiments, the heteroatom dopant precursor is a sulfur and nitrogen precursor such as thiourea, thioacetamide, L-cysteine, methionine, dithiocarbamates, dithiooxamide, thiazoles such as 2-aminothiazole, 5-amino-1,3,4-thiadiazole-2-thiol, thiosemicarbazide, and thiocarbohydrazide.

In specific embodiments, the heteroatom dopant precursor is a boron and an oxygen precursor such as boric acid, boron trioxide, sodium borate, and borax.

In specific embodiments, for step (a), the carbon precursor and the template material are in a weight ratio of from about 2:10 to about 4:10.

In specific embodiments, for step (a), the carbon precursor and the template material are in a weight ratio of from about 3:10.

In specific embodiments, for step (a), the heteroatom dopant precursor and the template material are in a weight ratio of about 1:12 to about 1:4.

In specific embodiments, for step (a), the heteroatom dopant precursor and the template material are in a weight ratio of about 1:10.

In specific embodiments, for step (a), the heteroatom dopant precursor and the carbon precursor are loaded onto the template material through impregnation.

In specific embodiments, for step (a), a solution of the carbon precursor in water and a solution of the heteroatom dopant precursor in water are prepared separately and then added dropwise to the template material to form loaded template material.

In specific embodiments, for step (a), the water used to prepare the solutions and the template material is in a weight ratio of from about 1:1 to about 2:1.

In specific embodiments, for step (a), the water used to prepare the solutions and the template material is in a weight ratio of about 4:3.

In specific embodiments, the template material is further loaded with a dehydration agent before step (b).

In specific embodiments, the dehydration agent is selected from the group consisting of sulfuric acid, formic acid, acetic acid and citric acid.

In specific embodiments, for step (b), the removal of moisture and volatiles is conducted through heating.

In specific embodiments, for step (b), the loaded template material obtained from step (a) is heated at about 100° C. and then at about 160° C. to remove moisture and volatiles therefrom.

In specific embodiments, for step (b), the loaded template material obtained from step (a) is heated at about 100° C. for about 6 hours and then at about 160° C. for about 6 hours to remove moisture and volatiles therefrom.

In specific embodiments, for step (c), the activating agent is selected from a zinc compound, phosphoric acid, potassium acetate, sodium hydroxide, potassium carbonate, ammonium carbonate, and ammonium persulfate.

In specific embodiments, the zinc compound is selected from the group consisting of ZnCl₂ and ZnO.

In specific embodiments, for step (c), the activating agent and the template material are in a weight ratio of from about 1:6 to about 4:3.

In specific embodiments, for step (c), the activating agent and the template material are in a weight ratio of from about 2:3.

In specific embodiments, for step (c), the activating agent is introduced as dry solid to the composition.

In specific embodiments, the loaded template material obtained from step (b) or the composition obtained from step (c) is subject to pulverisation before step (d).

In specific embodiments, for step (d), the composition obtained from step (c) is activated and carbonised at a temperature of about 600° C. to about 900° C. for about 5 hours.

In specific embodiments, for step (d), the composition obtained from step (c) is activated and carbonised at a temperature of about 800° C. for about 5 hours.

In specific embodiments, for step (d), the activation and carbonisation is conducted under an inert atmosphere.

In specific embodiments, for step (e), the composition obtained from step (d) is treated with HCl to remove the activating agent and with HF to remove the template material.

In specific embodiments, the doped activated nanoporous carbon material has a nitrogen content of from about 0.25% to about 15.00% by weight.

In specific embodiments, the doped activated nanoporous carbon material has a specific capacitance of more than about 200 F/g at a current density of 0.3 A/g.

In specific embodiments, the doped activated nanoporous carbon material has a specific capacitance of about 299 F/g at a current density of 0.3 A/g.

In specific embodiments, the doped activated nanoporous carbon material has a specific capacitance of about 299 F/g, about 228 F/g, about 194 F/g at a current density of 0.3 A/g, 0.5 A/g, and 1 A/g.

In specific embodiments, the doped activated nanoporous carbon material has a specific surface area of from about 1350 m²/g to about 1700 m²/g.

In specific embodiments, the doped activated nanoporous carbon material has a specific surface area of from about 1500 m²/g to about 1700 m²/g.

In specific embodiments, the doped activated nanoporous carbon material has a specific surface area of from about 1600 m²/g to about 1700 m²/g.

In specific embodiments, the doped activated nanoporous carbon material has a pore volume of from about 1.000 cm³/g to about 1.600 cm³/g.

In specific embodiments, the doped activated nanoporous carbon material has a pore volume of from about 1.300 cm³/g to about 1.600 cm³/g.

In specific embodiments, the doped activated nanoporous carbon material has a pore volume of from about 1.400 cm³/g to about 1.600 cm³/g.

In specific embodiments, the doped activated nanoporous carbon material has a specific area of about 1700 m²/g and a pore volume of about 1.465 cm³/g.

In specific embodiments, the doped activated nanoporous carbon material has a CO₂ adsorption capacity of at least about 22.5 mmol/g when determined at 0° C. and 30 bar.

In specific embodiments, the doped activated nanoporous carbon material has a CO₂ adsorption capacity of about 24.4 mmol/g when determined at 0° C. and 30 bar.

Use of the doped activated nanoporous carbon material disclosed herein or the doped activated nanoporous carbon material prepared by the method disclosed herein in an anode material for sodium-ion or lithium-ion batteries.

Use of the doped activated nanoporous carbon material disclosed herein or the doped activated nanoporous carbon material prepared by the method disclosed herein in an electrode material for supercapacitors.

Use of the doped activated nanoporous carbon material disclosed herein or the doped activated nanoporous carbon material prepared by the method disclosed herein in absorption of CO₂.

Use of the doped activated nanoporous carbon material disclosed herein or the doped activated nanoporous carbon material prepared by the method disclosed herein for electrochemical energy storage and conversion.

Use of the doped activated nanoporous carbon material disclosed herein or the doped activated nanoporous carbon material prepared by the method disclosed herein for water/wastewater treatment.

Use of the doped activated nanoporous carbon material disclosed herein or the doped activated nanoporous carbon material prepared by the method disclosed herein in a fuel cell.

Use of the doped activated nanoporous carbon material disclosed herein or the doped activated nanoporous carbon material prepared by the method disclosed herein for thermocatalytic and/or electrocatalytic reactions.

Use of the doped activated nanoporous carbon material disclosed herein or the doped activated nanoporous carbon material prepared by the method disclosed herein in a sensor such as an enzymatic biosensor.

Use of the doped activated nanoporous carbon material disclosed herein or the doped activated nanoporous carbon material prepared by the method disclosed herein as an antimicrobial agent.

### EXAMPLES

### Example 1—Preparation of the N-Doped Activated Nanoporous Carbon Material Samples with Activation by ZnCl₂ and with Doping by Aminoguanidine

A nitrogen-doped activated nanoporous carbon sample were prepared by using 3 g of natural halloysite-kaolin nanoclay with a 40:60 ratio of halloysite (Al₂Si₂O₅(OH)₄·2H₂O):kaolinite (Al₂Si₂O₅(OH)₄) infiltrated with a solution containing sucrose (≥99.5%, 0.9 g), water (4 g), sulphuric acid (95-98%, 0.1008 g) and aminoguanidine hydrochloride (0.35 g). A solution of sucrose in water and a solution of aminoguanidine hydrochloride in water were prepared separately and then combined together with the other starting materials. The mixture obtained thereby was added dropwise to the halloysite-kaolin nanoclay powder. The halloysite-kaolin nanoclays loaded with sucrose, aminoguanidine hydrochloride and sulfuric acid were thoroughly mixed for about 15-20 minutes and then heated in a hot air oven at 100° C. for 6 h and the temperature was ramped to 160° C. and retained this temperature for another 6 h. After the heat treatment, the sample was pulverized manually into a fine powder and thoroughly mixed with zinc chloride as dry salt. The sample that contains zinc chloride were activated and carbonized in a horizontal quartz glass tube furnace at different temperatures 600, 700, 800 and 900° C., for 5 h using a temperature ramp rate of 3° C./min under a constant flow of nitrogen. After activation and carbonisation, zinc chloride and the nanoclays were to be removed. For this purpose, a 2M HCl solution was used to remove zinc chloride under stirring for about 2 hours. The sample was further rinsed with distilled water and filtered and repeated the washing step twice, filtered and then subjected to drying in an oven at about 100° C. overnight. Then the sample was again dissolved with a 5 wt % HF solution and stirred for about 2 hours to remove the halloysite-kaolin nanoclays. After this, the sample was filtered and rinsed with excess ethanol and then dried in an oven at about 100° C. overnight. A similar set of samples were prepared without adding zinc chloride to compare the effect of activation in improving the textural properties and the performance of the N-doped porous carbons (NHNCs).

### Results and Discussion

The N-doped activated nanoporous carbon materials were synthesised from the naturally available clay mineral through templating and a simple in situ doping combined with activation. A new nitrogen-rich precursor such as aminoguanidine hydrochloride was used as a nitrogen source and halloysite nanotube (HNT) as the sacrificial hard template while ZnCl₂ was used as the activation agent. The specific surface area and the pore volume for non-activated N doped porous carbon samples (NHNCs) prepared from sucrose and aminoguanidine precursors are in the range of 561 to 680 m² g⁻¹ and 0.822-0.989 cm³ g⁻¹ respectively. After activating with the zinc chloride, the specific surface area and the pore volume of N-ANCs increase to 1466-1649 m²·g- and 1.234 to 1.576 cm³ gi, respectively, suggesting that the introduction of zinc chloride can help in increasing the specific surface area and pore volume. The sample prepared at 800° C. is having the highest specific surface area (1649 m²/g) and the largest pore volume (1.576 cm³/g), whereas the samples prepared at 600° C. and 700° C. show lower specific surface areas and pore volume. The specific surface area for N-doped nanoporous carbon materials without zinc chloride activation is much lower than those with activation. However, both the activated and non-activated samples yield type IV isotherms with hysteresis loops (P/P₀>0.8), which highlights the mesoporous nature of these N-doped carbonaceous materials (Kim et al. 2019). The N₂ isotherms indicate the presence of mesopores and the type H3 hysteresis loop produced at a higher relative pressure implies a wide pore size distribution (Cheng et al.2019).

The Nitrogen content (˜10%) in the carbon framework of the sample carbonised at 800° C. is relatively higher than that of the other N-doped materials reported so far (Zhou et al. 2018; Lu et al. 2017; Kim et al. 2019; Zou et al. 2019) The morphology and structure of the N-ANCs materials were investigated by SEM (see FIGS. 5-7). The obtained N doped activated halloysite nanocarbon materials mainly consist of thin carbon sheets with an irregular flaky morphology and the tubular structure of halloysite can be rarely observed. The observed morphology of the N doped carbon materials could be due to the interactions between the carbon and nitrogen precursors and halloysite templates.

### Example 2—Preparation of the N-Doped Activated Nanoporous Carbon Material Sample(s) with Activation by ZnCl₂ and with Doping by 3-Amino 1,2,4-Triazole

The procedure of Example 1 was used to prepare the N-doped activated nanoporous carbon material sample except replacing 0.35 g of aminoguanidine hydrochloride with 0.3 g of 3-amino 1,2,4-triazole.

### Results and Discussion

The N-doped activated nanoporous carbon materials were synthesised from the naturally available clay mineral through templating and a simple in situ doping combined with activation. 3-amino-1,2,4-amino triazole was used as a nitrogen source and halloysite nanotube (HNT) as the sacrificial hard template while ZnCl₂ was used as the activation agent. The specific surface area and the pore volume for non-activated samples (NHNCx) prepared from sucrose and amino triazole precursors are in the range of 490 to 638 m² g⁻¹ and 0.77-1.00 cm³ g⁻¹ respectively. After activating with zinc chloride, the BET surface area and the pore volume of the N-doped activated nanoporous carbon materials increase to 1360 to 1695 m² g⁻¹ and 1.087 to 1.464 cm³ g⁻¹, respectively, suggesting that the introduction of zinc chloride can help in increasing the specific surface area and pore volume. Likewise, in the aminoguanidine precursor, the sample prepared with 3-amino-1,2,4-triazole at 800° C. is superior as it has the highest specific surface area (1695 m²/g) and the largest pore volume (1.464 cm³/g) (Table 3). The samples prepared at lower carbonisation temperature (600° C. and 700° C.) have the lower specific surface areas when compared to the material obtained at 800° C. The pore volume is also not remarkable as that of the carbon material prepared at 800° C. The specific surface area for N-doped carbon nanoflakes materials without the zinc chloride activation is much lower than those with activation. However, both the activated and non-activated materials yield type IV isotherms with hysteresis loops (P/P₀>0.8), which highlights the mesoporous nature of these N-doped carbonaceous materials (Kim et al. 2019). The N₂ isotherms indicate the presence of mesopores and the type H3 hysteresis loop produced at a higher relative pressure implies a wide pore size distribution (Cheng et al.2019).

TABLE 3
Textural properties of the N doped activated porous
carbon prepared with 3-amino-1,2,4-triazole
carbonised at different temperatures

| | Specific | |
|---|---|---|
| | Surface | Pore |
| Carbonisation | Area | volume |
| temp ° C. | m² · g⁻¹ | cm³g⁻¹ |
| 600 | 1360 | 1.087 |
| 700 | 1571 | 1.328 |
| 800 | 1695 | 1.464 |
| 900 | 1437 | 1.384 |

### Control Example—Preparation of the Activated Nanoporous Carbon Material without Doped Nitrogen

In a typical synthesis of the activated nanoporous carbon through clay templating method, 3 g of natural halloysite-kaolin nanoclays was impregnated with a sucrose solution prepared by dissolving 0.9 g of sucrose in 4 g water and adding sulphuric acid (0.1008 g). The resulting mixture was thoroughly mixed for about 15-20 minutes before being transferred to a hot air oven. Initially, the mixture was heated at 100° C. for 6 h and thereafter the temperature was increased to 160° C. and maintained for another 6 h. After the heat treatment, the mixture is pulverized into a fine powder using a mortar and pestle. ZnCl₂ was added as dry salt to the heated nanoclays-sucrose mixture, and the latter was thoroughly mixed by crushing and again heated to 600° C. for 5 h using a temperature ramp rate of 3° C./min under a constant flow of nitrogen. The carbonized sample was washed with 2 M HCl to remove ZnCl₂, rinsed in distilled water, filtered, dried and then further heated to 900° C. for 5 h using a temperature ramp rate of 5° C./min under a constant flow of nitrogen. After this, the obtained black powder was dissolved in a 5 wt % dilute HF solution and stirred for about 2 h, followed by filtration and washing with excess ethanol. The sample after filtration was dried overnight in a hot air oven at 100° C. before characterization.

Comparison of N-Doped Activated Nanoporous Carbon Material with Activated Nanoporous Carbon Material without Nitrogen Doping

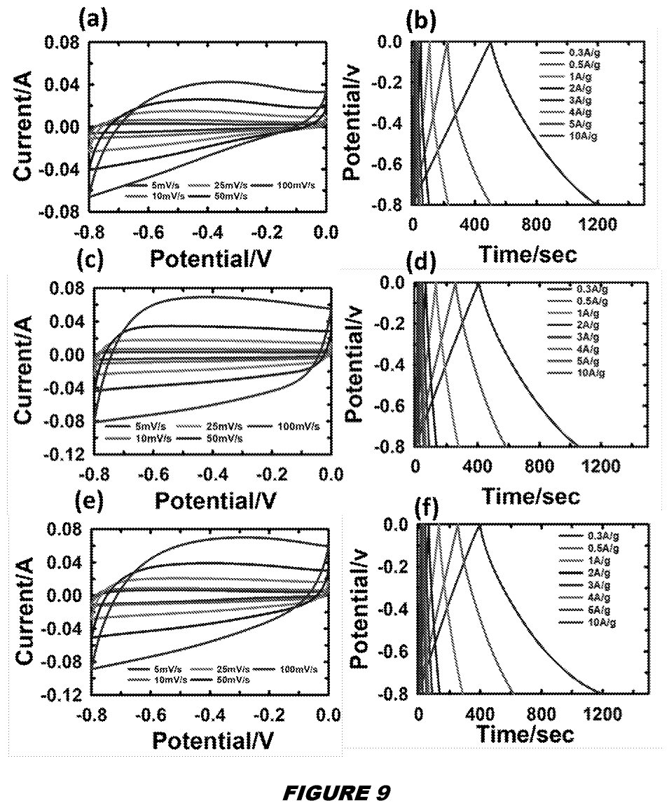

The N-ANCx samples were used to fabricate electrodes and tested for supercapacitor performance in a standard method of electrode testing using a three-electrode cell configuration. The electrolyte used for the capacitance measurement is 3M aqueous KOH. The scan rate for obtaining the cyclic voltammetry (CV) curves was varied from 5 to 100 mV s⁻¹. The CV curves show a nearly rectangular shape which indicates the superior charge storage ability and high efficiency, and this also confirms that N-ANCx materials possess the characteristics of an ideal electrical double-layer capacitor (EDLC). It should be noted that the shape of the CV curve in N-ANC₇₀₀ sample is not as rectangular as N-ANC₈₀₀ and N-ANC₉₀₀. The quasi-rectangular shape of the CV curves of N-ANC₈₀₀ and N-ANC₉₀₀ is retained even when the scan rate ramped up to 100 mV s⁻¹ which implied a rapid electron transport in the charge/discharge cycling process. The current density range selected for the galvanostatic charge-discharge (GCD) cycling process is from 0.3 to 10 A g⁻¹ and the GCD profiles of the N-ANCx materials revealed no significant drop in the IR voltage and the shape of the profiles is almost linear and symmetrical, which confirms that N-ANC₈₀₀ and N-ANC₉₀₀ materials have high specific capacitance and can be an efficient electrode for the electrical double layer capacitor (FIGS. 9(a-f)).

FIG. 10(a) displays the CV curves of the N-ANCx materials obtained at the scan rate of 10 mV s⁻¹ and this clearly explained that the quasi-rectangular shape of N-ANC₈₀₀ and N-ANC₉₀₀ is better than the CV of N-ANC₇₀₀ sample. The specific capacitance of N-ANC₉₀₀ at a current density of 0.3 A g⁻¹ is 299 F g⁻¹ which drops to 194 F g⁻¹ when the current density is increased to 1 A g⁻¹. Among the N-ANCx materials studied, N-ANC₉₀₀ registers the highest capacitance (194 F g⁻¹) than N-ANC₈₀₀ (183 F g 1) and N-ANC₇₀₀ (151 F g⁻¹) at 1 A g⁻¹ even though N-ANC₈₀₀ exhibits the highest specific surface area and the pore volume (FIG. 10(b)). The material N-ANC₉₀₀ exhibited a higher capacitance value (194 F g⁻¹/1 A g⁻¹) than our previously reported material AHNC which is the activated porous carbon nanoflakes derived from halloysite nanotubes without N-doping (158 F g⁻¹/1 A g⁻¹) (Ramadass et al. 2020).

Generally, at higher current densities, a lower capacitance value is observed due to the shorter time for the electrolyte ions permeation into the electrode materials (Yanilmaz, et al. 2017). However, N-ANC₈₀₀ and N-ANC₉₀₀ materials provide an abundant inner surface for good diffusion of electrolyte ions even at higher current densities, hence fairly high specific capacitance of 148 F g⁻¹ at 10 A g⁻¹ current density was noticed, demonstrating their better capacitance ability at higher current densities.

Electrochemical Impedance (EIS) analysis was also conducted to investigate the electrochemical behaviour of the electrodes prepared using N-ANCx samples and Nyquist plots were obtained from the EIS analysis (FIG. 10(c)). A typical Nyquist plot of EDLC shows a semi-circular curve in the high-frequency and a vertical straight line at the low-frequency zones. The Nyquist plots of N-ANC₈₀₀ and N-ANC₉₀₀ show a perpendicular line in the low-frequency area which confirms the good electrochemical behaviour and also quick permeation of electrolyte ions in the material's surface. The semi-circular arc noticed in the high-frequency Nyquist plot of N-ANC₈₀₀ and N-ANC₉₀₀ samples implies a fast electron transport between the electrodes and the electrolyte. It is found that the supercapacitance value obtained for N-ANC₉₀₀ (FIG. 10(d)) in this work exceeds the supercapacitance value reported for the commercially available single and multiwalled walled CNTs, activated carbon, ordered mesoporous carbons, activated porous carbon from HNT and few other carbon-based materials reported so far (Mansuer, et al. 2021).

The data in table 1 shows that N-ANC₉₀₀ outweighs the performance of N-doped porous carbon materials such as nitrogen-doped carbon nanofibres, casein-derived porous carbon, coffee waste-derived nitrogen-doped carbon reported in the recent literature. The exceptional performance of N-ANC₉₀₀ is because of the homogeneous N doping into the nanostructure of porous carbon, which enhances surface wettability. A combination of high specific surface area and large pore volume originating from the interconnected meso and microchannels in the tubular network further improves the rate performance. The enhanced electrochemical behaviour of N-ANC₉₀₀ is due to the perfect nanoarchitecture, which is favourable for increased ion access and fast diffusion. The presence of hierarchical pore distribution offers an advantage in enhancing electrochemical behavior. The microporous structure helps to create the electrical double layers, and the mesopores shorten the length between the electrolyte-electrode interface (Song et al. 2021). The cycling performance test was done for N-ANC₉₀₀ material. The specific capacitance retention is about 91% even after long runs of the charge/discharge process (4000 Cycles at 5 A g⁻¹ current density), suggesting that the electrodes prepared from N-ANC₉₀₀ material are highly stable and have excellent cycling performance. It is known that the carbon framework collapses when the heteroatoms are loaded in high amounts, which leads to the reduced stability of the electrodes; however, in this study, high N doping was successfully done through an effective combined in-situ nanotemplating and activation approach.

The excellent cycling ability of the electrode fabricated from N-ANC₉₀₀ suggests that N atoms are successfully incorporated into the nanoporous carbon framework without affecting its nanostructure (Zhou et al. 2020). Although N-ANC₈₀₀ possesses the highest specific surface area, the specific capacitance is lower than N-ANC₉₀₀. This could be due to a combination of a high specific surface area, high nitrogen content and most importantly, high crystallinity generated at a high carbonization temperature that contributed towards superior specific capacitance for the material prepared at 900° C. The excellent performance of N-ANC₉₀₀ reveals the importance of the combined treatment of doping, templating and activation adopted in this work. The excellent textural parameters, when combined with the crystallinity, uniform distribution of N atoms in the porous carbon structure and oxygen functional groups generated through the extensive oxidation, occurred due to the high-temperature carbonization and activation with ZnCl₂, helps to achieve the superior specific capacitance for the N-ANC₉₀₀.

### Example 3—Specific Capacitance of the N-Doped Activated Nanoporous Carbon Material

Supercapacitor measurements were performed on a CHI760E (CH instruments) work station in 6 M KOH aqueous electrolyte solution under three-electrode assembly using Pt rod and Ag/AgCl as counter and reference electrodes respectively. Electrochemical impedance spectroscopy (EIS) measurements were studied by applying an AC voltage with 10 mV amplitude in the frequency range from 0.01 Hz to 100 kHz. A galvanostatic charge-discharge (GCD) test was also conducted at different current densities.

The specific capacitance (Csp) was calculated using the following formula from CV,

Csp=(i+−i−)/(m×scan rate)

wherein i+ and i− are the maximum values of current in the positive and negative scans respectively, and m is the mass of the single electrode.

Specific capacitance was calculated from galvanostatic charge-discharge curves using the formula,

Csp=(i)(dt)/(m×dv)

wherein i is the discharge current and dt/dv is the slope of the discharge curve.

Electrochemical performance of the N-doped activated nanoporous carbons were investigated by means of cyclic voltammetry (CV), galvanostatic charge-discharge curves and electrochemical impedance spectroscopy (EIS) in 6 M H₂SO₄ aqueous electrolyte. Cyclic voltammograms (CV) were measured at different scan rates (5-100 mV/s) were shown FIG. 10. It is observed that the peak current increases with increase in scan rate. The CV of the N doped activated nanoporous carbon shows quasi-rectangular curves indicating the excellent supercapacitance behaviour of the material. The specific capacitance obtained from CV is around 228 F/g at 0.3 A/g current density. The constant current charge-discharge curves for the materials were measured in a potential window of 0 to −0.8 V vs Ag/AgCl (3M KOH). FIG. 9 shows charge-discharge curves measured at different current densities (0.3-5 A/g). The discharge curves look almost triangular resembling those of an ideal capacitor. Generally, with the increase of the current density, the specific capacitance gradually decreases owing to the presence of aperture limit, the shorter the charging time of the capacitor at higher current density, the electrolyte ion cannot thoroughly into the inner space of carbon materials, resulting in the reduction of the effective specific surface area which decreases the specific capacitance. However, the N-doped carbon materials prepared according to the present disclosure showed a specific capacitance of about 153 F/g even at a current density of 5 A/g, demonstrating a good rate performance of the N-doped activated nanoporous carbon materials carbonised at 900° C.

### Example 4—CO₂ Adsorption by the N-Doped Activated Nanoporous Carbon Material

CO₂ adsorption isotherms were measured in a range of pressures (0-30 bar) on a Micromeritics HPVA fitted with a temperature-controlled circulator. CO₂ adsorption was measured at three different temperatures of 0° C., 10° C. and 25° C. Sample degassing was carried out at 250° C. for 10 h prior to all measurements. The CO₂ adsorption capacity of the N-doped activated nanoporous carbon materials carbonised at 800° C. was 24.4 mmol g⁻¹, and the CO₂ adsorption capacity of the N-doped activated nanoporous carbon materials carbonised at 700° C. was 21.6 mmol g⁻¹ at 0° C. and 30 bar. For the N-doped activated nanoporous carbon materials carbonised at 800° C., the CO₂ adsorption experiments were also conducted at different temperatures (0° C., 10° C. and 25° C.) with pressures varying from 0 to 30 bar (FIG. 8(b)). When 30 bar pressure of CO₂ was applied, the highest CO₂ adsorption was about 24.4 mmol g⁻¹ at 0° C., whereas, at a low pressure of 0-1 bar, the CO₂ adsorption capacity was 3.9 mmol g⁻¹ at 0° C. This increase in CO₂ adsorption with increasing the pressure suggests that the CO₂ adsorption process was exothermic in nature. On the other hand, the adsorption decreases with increasing temperature. For example, at the low pressure of 0-1 bar, the CO₂ adsorption capacity at 25° C. is 2.0 mmol g⁻¹, which is almost half of that at 0° C.

### Example 5—Preparation of S- and N Doped Activated Nanoporous Carbon Material Sample(s) with Activation by ZnCl₂ and with Doping by Thiourea

A Sulphur and Nitrogen-doped activated nanoporous carbon sample was prepared using 3 g of natural halloysite-kaolin nanoclay with a 40:60 ratio of halloysite (Al₂Si₂O₅(OH)₄·2H₂O):kaolinite (Al₂Si₂O₅(OH)₄) infiltrated with a solution containing sucrose (>99.5%, 0.9 g), water (5 g), sulphuric acid (95-98%, 0.1008 g) and thiourea (0.35 g). A solution of sucrose in water and a solution of thiourea in water were prepared separately and then combined together with the other starting materials. The mixture obtained thereby was added dropwise to the halloysite-kaolin nanoclay powder. The halloysite-kaolin nanoclays loaded with sucrose, thiourea and sulfuric acid were thoroughly mixed for about 15-20 minutes and then heated in a hot air oven at 100° C. for 6 h and the temperature was ramped to 160° C. and retained this temperature for another 6 h. After the heat treatment, the sample was pulverized manually into a fine powder and thoroughly mixed with zinc chloride as dry salt. The sample that contains zinc chloride were activated and carbonized in a horizontal quartz glass tube furnace at different temperatures, 700 and 800° C., for 5 h using a temperature ramp rate of 3° C./min under a constant flow of nitrogen. After activation and carbonisation, zinc chloride and the nanoclays were removed. For this purpose, a 2M HCl solution was used to remove zinc chloride under stirring for about 2 hours. The sample was further rinsed with distilled water and filtered and repeated the washing step twice, filtered and then subjected to drying in an oven at about 100° C. overnight. Then the sample was again dissolved with a 5 wt % HF solution and stirred for about 2 hours to remove the halloysite-kaolin nanoclays. After this, the sample was filtered and rinsed with excess ethanol and then dried in an oven at about 100° C. overnight.

TABLE 4
Textural properties of the S-N doped activated porous
carbon prepared with thiourea carbonised at different temperatures

| | | Specific | |
|---|---|---|---|
| | | Surface | Pore |
| Carbonisation | | Area | volume |
| temp ° C. | Thiourea (g) | m² · g⁻¹ | cm³g⁻¹ |
| 700 | 0.25 | 1571 | 1.122 |
| 800 | 0.25 | 1676 | 1.389 |
| 700 | 0.35 | 1525 | 1.238 |
| 800 | 0.35 | 1600 | 1.461 |
| 700 | 0.45 | 1605 | 1.289 |
| 800 | 0.45 | 1686 | 1.312 |

A similar set of samples were prepared without adding zinc chloride to compare the effect of activation in improving the textural properties and the performance of the S and N-doped porous carbons (S-N-HNCs).

TABLE 5
Comparison of textural properties of S-N-doped
activated nanoporous carbon with S and N-doped
nanoporous carbons (S-N-HNC) prepared without activation

| | | Specific | |
|---|---|---|---|
| | | Surface | Pore |
| Carbonisation | | Area | volume |
| temp ° C. | Thiourea (g) | m² · g⁻¹ | cm³g⁻¹ |
| 800 | 0.35 | 595 | 0.954 |
| 800 | 0.35 | 1600 | 1.461 |

### Example 6—Preparation of B-Doped Activated Nanoporous Carbon Material Sample(s) with Activation by ZnCl₂ and with Doping by Boric Acid

A boron-doped activated nanoporous carbon sample were prepared by using 3 g of natural halloysite-kaolin nanoclay with a 40:60 ratio of halloysite (Al₂Si₂O₅(OH)₄·2H₂O):kaolinite (Al₂Si₂O₅(OH)₄) infiltrated with a solution containing sucrose (>99.5%, 0.9 g), water (6 g), sulphuric acid (95-98%, 0.1008 g) and boric acid (0.35 g). A solution of sucrose in water and a solution of boric acid in water were prepared separately and then combined with the other starting materials. The mixture obtained thereby was added dropwise to the halloysite-kaolin nanoclay powder. The halloysite-kaolin nanoclays loaded with sucrose, boric acid and sulfuric acid were thoroughly mixed for about 15-20 minutes and then heated in a hot air oven at 100° C. for 6 h and the temperature was ramped to 160° C. and retained this temperature for another 6 h. After the heat treatment, the sample was pulverized manually into a fine powder and thoroughly mixed with zinc chloride as dry salt. The sample that contains zinc chloride were activated and carbonized in a horizontal quartz glass tube furnace at different temperatures, 800 and 900° C., for 5 h using a temperature ramp rate of 3° C./min under a constant flow of nitrogen. After activation and carbonisation, zinc chloride and the nanoclays were to be removed. For this purpose, a 2M HCl solution was used to remove zinc chloride under stirring for about 2 hours. The sample was further rinsed with distilled water and filtered and repeated the washing step twice, filtered and then subjected to drying in an oven at about 100° C. overnight. Then the sample was again dissolved with a 5 wt % HF solution and stirred for about 2 hours to remove the halloysite-kaolin nanoclays. After this, the sample was filtered and rinsed with excess ethanol and then dried in an oven at about 100° C. overnight.

TABLE 6
Textural properties of the B-doped activated porous carbon
prepared with boric acid carbonised at different temperatures

| | | Specific | |
|---|---|---|---|
| | | Surface | Pore |
| Carbonisation | | Area | volume |
| temp ° C. | Boric acid (g) | m² · g⁻¹ | cm³g⁻¹ |
| 800 | 0.25 | 1962 | 1.773 |
| 900 | 0.25 | 1214 | 1.307 |
| 800 | 0.35 | 1746 | 1.853 |
| 900 | 0.35 | 1173 | 1.502 |
| 800 | 0.45 | 1262 | 1.334 |
| 900 | 0.45 | 1039 | 0.987 |

A similar set of samples were prepared without adding zinc chloride to compare the effect of activation in improving the textural properties and the performance of the B-doped porous carbons (B-HNCs).

TABLE 7
Comparison of textural properties of B-doped
activated nanoporous carbon with B-doped
nanoporous carbons (B-HNC) prepared without activation.

| | | Specific | |
|---|---|---|---|
| | | Surface | Pore |
| Carbonisation | | Area | volume |
| temp ° C. | Boric acid (g) | m² · g⁻¹ | cm³g⁻¹ |
| 800 | 0.35 | 848 | 1.320 |
| 800 | 0.35 | 1746 | 1.853 |

### Example 7—Preparation of N-Doped Activated Nanoporous Carbon Material Sample(s) from Different Clay Templates with Activation by ZnCl₂ and with Doping by Aminotriazole

To understand the uniqueness of the kaolin-halloysite mixed clay as a natural nano template for the preparation of the N-doped activated nanoporous carbon, different types of other clay materials were used as templates for the synthesis of the N-doped activated nanoporous carbon. Halloysite (100%), kaolinite (100%), attapulgite, bentonite were used as the templates. The experimental procedure was the same as mentioned in Example 1 except replacing the kaolin-halloysite mixed clay template with the other clay template.

TABLE 8
Textural properties of the N-doped activated porous carbon prepared
with different clay templates carbonised at different temperatures

| | | | Specific | Pore |
|---|---|---|---|---|
| Carbonisation | | | Surface Area | volume |
| temp ° C. | Template used | Chemical formula (template) | m² · g⁻¹ | cm³g⁻¹ |
| 800 | Halloysite (100%) | Al₂Si₂O₅(OH)₄•nH₂O | 1002 | 1.639 |
| 900 | Halloysite (100%) | | 1142 | 1.758 |
| 800 | Kaolinite (100%) | Al₂Si₂O₅(OH)₄•nH₂O | 1124 | 1.064 |
| 900 | Kaolinite (100%) | | 1170 | 1.308 |
| 800 | Attapulgite | (Mg, Al) 2Si₄O₁₀(OH)•4(H₂O) | 412 | 0.613 |
| 900 | Attapulgite | | 346 | 0.445 |
| 800 | Bentonite | Al₂H₂Na₂O₁₃Si₄ | 395 | 0.538 |
| 900 | Bentonite | | 358 | 0.312 |

Although embodiment(s) of the present invention have been described in the foregoing detailed description, it will be understood that the invention is not limited to the embodiment(s) disclosed, but is capable of numerous rearrangements, modifications and substitutions without departing from the scope of the invention.

Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

### REFERENCES

Y. Zhou, A. M. LaChance, A. T. Smith, H. Cheng, Q. Liu, L. Sun, Strategic Design of Clay-Based Multifunctional Materials: From Natural Minerals to Nanostructured Membranes, Adv Funct Mater 29(16) (2019) 1807611.
Y. Lu, L. Wang, K. PreuB, M. Qiao, M.-M. Titirici, J. Varcoe, Q. Cai, Halloysite-derived nitrogen doped carbon electrocatalysts for anion exchange membrane fuel cells, Journal of Power Sources 372 (2017) 82-90.
C. Kim, C. Zhu, Y. Aoki, H. Habazaki, Heteroatom-doped porous carbon with tunable pore structure and high specific surface area for high performance supercapacitors, Electrochim Acta 314 (2019) 173-187.
K. Zou, Y. Deng, J. Chen, Y. Qian, Y. Yang, Y. Li, G. Chen, Hierarchically porous nitrogen-doped carbon derived from the activation of agriculture waste by potassium hydroxide and urea for high-performance supercapacitors, Journal of Power Sources 378 (2018) 579-588.
Y. Cheng, Q. Zhang, C. Fang, Z. Huang, J. Chen, L. Wu, H. Wang, Synthesis of N-Doped Porous Carbon Materials Derived from Waste Cellulose Acetate Fiber via Urea Activation and Its Potential Application in Supercapacitors, J Electrochem Soc 166(6) (2019) A1231-A1238.
Ariharan, B. Viswanathan, V. Nandhakumar, Nitrogen-incorporated carbon nanotube derived from polystyrene and polypyrrole as hydrogen storage material, International Journal of Hydrogen Energy 43(10) (2018) 5077-5088.
Y. Cheng, Q. Zhang, C. Fang, Z. Huang, J. Chen, L. Wu, H. Wang, Synthesis of N-Doped Porous Carbon Materials Derived from Waste Cellulose Acetate Fiber via Urea Activation and Its Potential Application in Supercapacitors, J Electrochem Soc 166(6) (2019) A1231-A1238.
S. Wang, J. Qin, Y. Zhao, L. Duan, J. Wang, W. Gao, R. Wang, C. Wang, M. Pal, Z.-S. Wu, W. Li, D. Zhao, Ultrahigh Surface Area N-Doped Hierarchically Porous Carbon for Enhanced CO2 Capture and Electrochemical Energy Storage, Chemsuschem 0(0).
J. Zhu, J. Yang, R. Miao, Z. Yao, X. Zhuang, X. Feng, Nitrogen-enriched, ordered mesoporous carbons for potential electrochemical energy storage, Journal of Materials Chemistry A 4(6) (2016) 2286-2292.
F. Xu, Z. Tang, S. Huang, L. Chen, Y. Liang, W. Mai, H. Zhong, R. Fu, D. Wu, Facile synthesis of ultrahigh-surface-area hollow carbon nanospheres for enhanced adsorption and energy storage, Nature communications 6 (2015) 7221.
S. Ahmed, M. Rafat, A. Ahmed, Nitrogen doped activated carbon derived from orange peel for supercapacitor application, Advances in Natural Sciences: Nanoscience and Nanotechnology 9(3) (2018) 035008.
Y. Zhu, M. Chen, Y. zhang, W. Zhao, C. Wang, A biomass-derived nitrogen-doped porous carbon for high-energy supercapacitor, Carbon 140 (2018) 404-412.
J. Qu, C. Geng, S. Lv, G. Shao, S. Ma, M. Wu, Nitrogen, oxygen and phosphorus decorated porous carbons derived from shrimp shells for supercapacitors, Electrochim Acta 176 (2015) 982-988.
Singh, G.; Bahadur, R.; Ruban, A. M.; Davidraj, J. M.; Su, D.; Vinu, A. Synthesis of functionalized nanoporous biocarbons with high surface area for CO₂ capture and supercapacitor applications. Green Chem. 2021, 23 (15), 5571-5583.
Singh, G.; Lakhi, K. S.; Kim, I. Y.; Kim, S.; Srivastava, P.; Naidu, R.; Vinu, A. Highly efficient method for the synthesis of activated mesoporous biocarbons with extremely high surface area for high-pressure CO₂ adsorption. ACS Appld. Mater. Interfaces 2017, 9 (35), 29782-29793.
Singh, G.; Kim, I. Y.; Lakhi, K. S.; Joseph, S.; Srivastava, P.; Naidu, R.; Vinu, A. Heteroatom functionalized activated porous biocarbons and their excellent performance for CO 2 capture at high pressure. J. Mater. Chem. A 2017, 5 (40), 21196-21204.
Zhou, S.; Xu, H.; Yuan, Q.; Shen, H.; Zhu, X.; Liu, Y.; Gan, W. N-Doped ordered mesoporous carbon originated from a green biological dye for electrochemical sensing and high-pressure CO₂ storage. ACS Appld. Mater. Interfaces 2015, 8 (1), 918-926.
Li, Y.; Cao, M. Synthesis of High-Surface-Area Nitrogen-Doped Porous Carbon Microflowers and Their Efficient Carbon Dioxide Capture Performance. Chem. An Asian J. 2015, 10 (7), 1496-1504.
S. Wang, J. Qin, Y. Zhao, L. Duan, J. Wang, W. Gao, R. Wang, C. Wang, M. Pal, Z.-S. Wu, W. Li, D. Zhao, Ultrahigh Surface Area N-Doped Hierarchically Porous Carbon for Enhanced CO₂ Capture and Electrochemical Energy Storage, Chemsuschem 12(15) (2019) 3541-3549.
Choi, J.; Zequine, C.; Bhoyate, S.; Lin, W.; Li, X.; Kahol, P.; Gupta, R. Waste Coffee Management: Deriving High-Performance Supercapacitors Using Nitrogen-Doped Coffee-Derived Carbon. Carbon 2019, 5 (3), 44.
M. Sevilla, A. S. M. Al-Jumialy, A. B. Fuertes, R. Mokaya, Optimization of the Pore Structure of Biomass-Based Carbons in Relation to Their Use for CO₂ Capture under Low- and High-Pressure Regimes, ACS Appld. Mater. Interfaces 10(2) (2018) 1623-1633.
Zhao, X.; Nie, G.; Luan, Y.; Wang, X.; Yan, S.; Long, Y.-Z. Nitrogen-doped carbon networks derived from the electrospun polyacrylonitrile@branched polyethylenimine nanofibers as flexible supercapacitor electrodes. J. Alloys Compd. 2019, 808, 151737.
Kavitha Ramadass; C. I. Sathish; Sujanya MariaRuban; Gopalakrishnan Kothandam; Stalin Joseph; Gurwinder Singh; Sungho Kim; Wangsoo Cha; Ajay Karakoti; Tony Belperio; Jia Bao Yi; and Ajayan Vinu. Carbon Nanoflakes and Nanotubes from Halloysite Nanoclays and their Superior Performance in CO₂ Capture and Energy Storage. ACS Applied Materials & Interfaces 2020 12 (10), 11922-11933.
A. Yanilmaz, A. Tomak, B. Akbali, C. Bacaksiz, E. Ozceri, O. Ari, R. T. Senger, Y. Selamet, H. M. Zareie, Nitrogen doping for facile and effective modification of graphene surfaces, RSC Advances 7(45) (2017) 28383-28392.https://doi.org/10.1039/C7RA03046K.
M. Mansuer, L. Miao, D. Zhu, H. Duan, Y. Lv, L. Li, M. Liu, L. Gan, Facile construction of highly redox active carbons with regular micropores and rod-like morphology towards high-energy supercapacitors, Mater. Chem. Front. 5(7) (2021) 3061-3072.
Z. Song, L. Miao, L. Ruhlmann, Y. Lv, D. Zhu, L. Li, L. Gan, M. Liu, Self-Assembled Carbon Superstructures Achieving Ultra-Stable and Fast Proton-Coupled Charge Storage Kinetics, Adv. Mater. 33(49) (2021) 2104148.
Z. Zhou, L. Miao, H. Duan, Z. Wang, Y. Lv, W. Xiong, D. Zhu, L. Li, M. Liu, L. Gan, Highly active N, O-doped hierarchical porous carbons for high-energy supercapacitors, Chinese Chem. Lett. 31(5) (2020) 1226-1230.

1. A doped activated nanoporous carbon material prepared from a template material comprising natural halloysite-kaolin nanoclays, a carbon precursor, a heteroatom dopant precursor and an activating agent, wherein the doped activated nanoporous carbon material exhibits a flake and nanotubular morphology and bears surface heteroatom functionalities.

2. The doped activated nanoporous carbon material according to claim 1, wherein the template material consists of natural halloysite-kaolin nanoclays.

3. The doped activated nanoporous carbon material according to claim 1, wherein the natural halloysite-kaolin nanoclays contain more than 40% by weight of halloysite nanotubes.

4. (canceled)

5. (canceled)

6. The doped activated nanoporous carbon material according to claim 1, wherein the carbon precursor is a sugar-based compound selected from the group consisting of sucrose, glucose, fructose and polysaccharides.

7. (canceled)

8. The doped activated nanoporous carbon material according to claim 6, wherein the polysaccharides are selected from the group consisting of cellulose, chitosan and starch.

9. (canceled)

10. The doped activated nanoporous carbon material according to claim 1 wherein the heteroatom dopant precursor is selected from one or more of the group consisting of a nitrogen precursor, a sulfur precursor, a boron precursor and an oxygen precursor.

11. The doped activated nanoporous carbon material according to claim 10, wherein the nitrogen precursor is selected from the group consisting of aminoguanidine, aminoguanidine hydrochloride, aminotriazoles, urea, chitosan, cyanamide, dicyanamide, thiourea, melamine, casein, polyaniline, polypyrrole, aminotetrazoles, and aminotriazines, the sulfur precursor is selected from one or more of the group consisting of diphenyl disulphide, polyphenylene sulfide, bis(trimethylsilyl) sulfide, alkyl thiol, thiophene, sulphur powder, sodium sulphide, sodium dithionite, sodium thiosulfate, thiourea, thioacetamide, L-cysteine, methionine, dithiocarbamates, dithiooxamide, thiazoles such as 2-aminothiazole, 5-amino-1,3,4-thiadiazole-2-thiol, thiosemicarbazide, and thiocarbohydrazide and the boron precursor is selected from one or more of the group consisting of boric acid, ammonia borane (borazane), diborane, trimethyl boron, colemanite, or boron trioxide, trimethoxy borane, sodium borate, borax, sodium borohydride, dimeric diborazane, trimeric triborazane, boron trifluoride, boron trichloride, and phenyl borate.

12. (canceled)

13. The doped activated nanoporous carbon material according to claim 1, wherein the activating agent is selected from the group consisting of a zinc compound, phosphoric acid, potassium acetate, sodium hydroxide, potassium carbonate, ammonium carbonate, and ammonium persulfate.

14. (canceled)

15. (canceled)

16. The doped activated nanoporous carbon material according to claim 1, which has a specific capacitance of about 299 F/g, about 228 F/g and about 194 F/g at a current density of 0.3 A/g, 0.5 A/g, and 1 A/g.

17. (canceled)

18. (canceled)

19. (canceled)

20. A method of preparing a doped activated nanoporous carbon material, which includes the following steps:
(a) loading a template material comprising natural halloysite-kaolin nanoclays with a carbon precursor and a heteroatom dopant precursor;
(b) removing moisture and volatiles from the loaded template material obtained from step (a);
(c) producing a composition comprising the loaded template material obtained from step (b) and an activating agent;
(d) activating and carbonising the composition obtained from step (c) at a temperature of about 600° C. to about 900° C.; and
(e) removing the template material and the activating agent from the composition obtained from step (d).

21. The method according to claim 20, wherein the template material consists of natural halloysite-kaolin nanoclays.

22. The method according to claim 21, wherein the natural halloysite-kaolin nanoclays contain more than 40% by weight of halloysite nanotubes.

23. (canceled)

24. The method according to claim 20, wherein for step (a), the carbon precursor is a sugar-based compound selected from the group consisting of sucrose, glucose, fructose, and polysaccharides.

25. (canceled)

26. (canceled)

27. The method according to claim 24, wherein the polysaccharides are selected from the group consisting of cellulose, chitosan and starch.

28. The method according to claim 20, wherein heteroatom dopant precursor is selected from one or more of the group consisting of a nitrogen precursor, a sulfur precursor, and a boron precursor.

29. The method according to claim 28, wherein the nitrogen precursor is selected from the group consisting of aminoguanidine, aminoguanidine hydrochloride, aminotriazoles, urea, chitosan, cyanamide, dicyanamide, thiourea, melamine, casein, polyaniline, polypyrrole, aminotetrazoles, and aminotriazines, the sulfur precursor is selected from one or more of the group consisting of diphenyl disulphide, polyphenylene sulfide, bis(trimethylsilyl) sulfide, alkyl thiol, thiophene, sulphur powder, sodium sulphide, sodium dithionite, sodium thiosulfate, thiourea, thioacetamide, L-cysteine, methionine, dithiocarbamates, dithiooxamide, thiazoles such as 2-aminothiazole, 5-amino-1,3,4-thiadiazole-2-thiol, thiosemicarbazide, and thiocarbohydrazide and the boric acid, ammonia borane (borazane), diborane, trimethyl boron, colemanite, or boron trioxide, trimethoxy borane, sodium borate, borax, sodium borohydride, dimeric diborazane, trimeric triborazane, boron trifluoride, boron trichloride, and phenyl borate.

30. (canceled)

31. (canceled)

32. (canceled)

33. The method according to claim 20, wherein the template material is further loaded with a dehydration agent before step (b).

34. (canceled)

35. The method according to claim 20, wherein for step (c), the activating agent is selected from a zinc compound, phosphoric acid, potassium acetate, sodium hydroxide, potassium carbonate, ammonium carbonate, and ammonium persulfate.

36. (canceled)

37. (canceled)

38. (canceled)

39. (canceled)

40. (canceled)

41. The method according to claim 20, wherein for step (e), the composition obtained from step (d) is treated with HCl to remove the activating agent and with HF to remove the template material.

42. Use of the doped activated nanoporous carbon material according to claim 1 as an anode material for sodium-ion or lithium-ion batteries, an electrode material for supercapacitors, for absorption of CO₂, for electrochemical energy storage and conversion, for water/wastewater treatment, in a fuel cell, for thermocatalytic and/or electrocatalytic reactions, in a sensor such as an enzymatic biosensor or as an antimicrobial agent.

43. Use of the doped activated nanoporous carbon material prepared by the method according to claim 20 as an anode material for sodium-ion or lithium-ion batteries, an electrode material for supercapacitors, for absorption of CO₂, for electrochemical energy storage and conversion, for water/wastewater treatment, in a fuel cell, for thermocatalytic and/or electrocatalytic reactions, in a sensor such as an enzymatic biosensor or as an antimicrobial agent.
